(19) United States
(12) Patent Application Publication
(10) Pub. No.: US 2025/0334729 A1
(43) Pub. Date: Oct. 30, 2025

(54) OPTICAL LAMINATE AND IMAGE DISPLAY APPARATUS

(71) Applicant: FUJIFILM Corporation, Tokyo (JP)

(72) Inventors: Fumitake MITOBE, Kanagawa (JP); Naoki KOITO, Kanagawa (JP)

(73) Assignee: FUJIFILM Corporation, Tokyo (JP)

(21) Appl. No.: 19/256,955

(22) Filed: Jul. 1, 2025

Related U.S. Application Data
(63) Continuation of application No. PCT/JP2024/003283, filed on Feb. 1, 2024.

(30) Foreign Application Priority Data
Feb. 16, 2023 (JP) 2023-022750

(51) Int. Cl. G02B 5/30

(52) U.S. Cl. CPC G02B 5/3016

(57) ABSTRACT

An optical laminate having the highest luminance in the vicinity of a front direction and having a luminance that is asymmetrical in a direction tilted from the front direction in a case where the optical laminate is applied to a light source, and an image display apparatus. The optical laminate includes a first light absorption anisotropic layer, a first retardation layer or a first liquid crystal cell, a second light absorption anisotropic layer, a second retardation layer or a second liquid crystal cell, and a third light absorption anisotropic layer in this order. Accordingly, various requirements are satisfied.

### CROSS-REFERENCE TO RELATED APPLICATIONS

This application is a Continuation of PCT International Application No. PCT/JP2024/003283 filed on Feb. 1, 2024, which was published under PCT Article 21(2) in Japanese, and which claims priority under 35 U.S.C. § 119(a) to Japanese Patent Application No. 2023-022750 filed on Feb. 16, 2023. The above applications are hereby expressly incorporated by reference, in their entirety, into the present application.

### BACKGROUND OF THE INVENTION

### 1. Field of the Invention

The present invention relates to an optical laminate and an image display apparatus.

### 2. Description of the Related Art

An image display apparatus such as a liquid crystal display device or an organic electroluminescence (EL) display device is frequently used as a display for a car navigation system, a smartphone, a laptop computer, or the like. In this display, an image can be observed from an observer in a desired direction. However, a control regarding a viewing angle direction may be required, for example, it is difficult to observe an image from the other directions.

As a viewing angle control system, for example, JP2012-103719A discloses a film-shaped viewing angle control system including an absorbing dichroic substance having an immobilized alignment, the viewing angle control system including a first polarizer and a second polarizer.

### SUMMARY OF THE INVENTION

On the other hand, recently, from the viewpoint of controlling light emitted from a light source, it is desired to realize an optical system having the highest luminance in the vicinity of a front direction of a light source and having different luminances between a direction tilted from the front direction to one azimuthal angle direction and a direction tilted to a side opposite to the azimuthal angle direction. In a case where the above-described optical system is applied to a display disposed in front of a passenger seat of a vehicle, an image is most conspicuous from the passenger seat side positioned in the front direction of the display, the display is visible to some extent from a cab seat side positioned on one side in a left-right direction of the display, and further reflected glare of the image of the display in a windshield positioned on the other side in the left-right direction of the display can be suppressed.

Hereinafter, having different luminances between a direction tilted from the front direction to one azimuthal angle direction and a direction tilted to a side opposite to the azimuthal angle direction will also be referred to as “having a luminance that is asymmetrical in a direction tilted from the front direction”.

Even in a case where the viewing angle control system described in JP2012-103719A is used, the above-described optical system cannot be realized.

An object of the present invention is to provide an optical laminate having the highest luminance in the vicinity of a front direction and having a luminance that is asymmetrical in a direction tilted from the front direction in a case where the optical laminate is applied to a light source.

In addition, another object of the present invention is to provide an image display apparatus.

The present inventors found that the object can be achieved by the following configurations.

(1) An optical laminate comprising, in the following order:
a first light absorption anisotropic layer;
a first retardation layer or a first liquid crystal cell;
a second light absorption anisotropic layer;
a second retardation layer or a second liquid crystal cell; and
a third light absorption anisotropic layer,
in which an angle A1 between a transmittance central axis of the first light absorption anisotropic layer and a normal direction of the first light absorption anisotropic layer is 0° to 45°,
an angle A2 between a transmittance central axis of the second light absorption anisotropic layer and a normal direction of the second light absorption anisotropic layer is more than 0° and 45° or less,
an angle A3 between a transmittance central axis of the third light absorption anisotropic layer and a normal direction of the third light absorption anisotropic layer is more than 0° and 45° or less,
the transmittance central axis of the first light absorption anisotropic layer and the transmittance central axis of the second light absorption anisotropic layer are not parallel to each other,
an angle between an orientation in an in-plane direction of the transmittance central axis of the second light absorption anisotropic layer and an orientation in an in-plane direction of the transmittance central axis of the third light absorption anisotropic layer is 180°±20°,
the first retardation layer has a function of changing a direction of linearly polarized light incident from a normal direction of the first retardation layer to a direction having an angle of 90°±10° with respect to the direction and emitting the incident light,
the second retardation layer has a function of changing a direction of linearly polarized light incident from a normal direction of the second retardation layer to a direction having an angle of 90°±10° with respect to the direction and emitting the incident light,
the first liquid crystal cell and the second liquid crystal cell are each independently a liquid crystal cell in a TN mode, a liquid crystal cell in a VA mode, a liquid crystal cell in an OCB mode, or a liquid crystal cell in an ECB mode,
the liquid crystal cell in the TN mode is a liquid crystal cell that rotates by 80° to 100° linearly polarized light incident into the liquid crystal cell from a normal direction of the liquid crystal cell in a case where a liquid crystal compound in the liquid crystal cell is twisted and aligned, and
all of the liquid crystal cell in the VA mode, the liquid crystal cell in the OCB mode, and the liquid crystal cell in the ECB mode are liquid crystal cells where an in-plane retardation at a wavelength of 550 nm is switchable between 0 to 20 nm and 250 to 300 nm.

(2) The optical laminate according to (1),
in which an absolute value of a difference between the angle A2 and the angle A3 is 8° or less.

(3) The optical laminate according to (1) or (2),
in which the first retardation layer and the second retardation layer are each independently selected from the group consisting of a retardation layer obtained by immobilizing a liquid crystal compound that is twisted and aligned along a helical axis extending along a thickness direction, a λ/2 plate, and a laminate where two λ/2 plates are laminated such that an angle between in-plane slow axes of the two λ/2 plates is in a range of 45°±10°.

(4) An optical laminate comprising, in the following order:
a first light absorption anisotropic layer;
a retardation layer or a liquid crystal cell; and
a second light absorption anisotropic layer,
in which an angle A1 between a transmittance central axis of the first light absorption anisotropic layer and a normal direction of the first light absorption anisotropic layer is more than 0° and 45° or less,
an angle A2 between a transmittance central axis of the second light absorption anisotropic layer and a normal direction of the second light absorption anisotropic layer is more than 0° and 45° or less,
the angle A1 and the angle A2 are different,
an angle between an orientation in an in-plane direction of the transmittance central axis of the first light absorption anisotropic layer and an orientation in an in-plane direction of the transmittance central axis of the second light absorption anisotropic layer is 180°±20°,
the retardation layer has a function of changing a direction of linearly polarized light incident from a normal direction of the retardation layer to a direction having an angle of 90°±10° with respect to the direction and emitting the incident light,
the liquid crystal cell is a liquid crystal cell in a TN mode, a liquid crystal cell in a VA mode, a liquid crystal cell in an OCB mode, or a liquid crystal cell in an ECB mode,
the liquid crystal cell in the TN mode is a liquid crystal cell that rotates by 80° to 100° linearly polarized light incident into the liquid crystal cell in a case where a liquid crystal compound in the liquid crystal cell is twisted and aligned, and
all of the liquid crystal cell in the VA mode, the liquid crystal cell in the OCB mode, and the liquid crystal cell in the ECB mode are liquid crystal cells where an in-plane retardation at a wavelength of 550 nm is switchable between 0 to 20 nm and 250 to 300 nm.

(5) The optical laminate according to (4),
in which the retardation layer is selected from the group consisting of a retardation layer obtained by immobilizing a liquid crystal compound that is twisted and aligned along a helical axis extending along a thickness direction, a λ/2 plate, and a laminate where two λ/2 plates are laminated such that an angle between in-plane slow axes of the two λ/2 plates is in a range of 45°±10°.

(6) An optical laminate comprising, in the following order:
a first light absorption anisotropic layer;
a first retardation layer or a first liquid crystal cell;
a second light absorption anisotropic layer;
a second retardation layer or a second liquid crystal cell; and
a third light absorption anisotropic layer,
in which an angle A1 between a transmittance central axis of the first light absorption anisotropic layer and a normal direction of the first light absorption anisotropic layer is 0° to 10°,
an angle A2 between a transmittance central axis of the second light absorption anisotropic layer and a normal direction of the second light absorption anisotropic layer is 0° to 10°,
an angle A3 between a transmittance central axis of the third light absorption anisotropic layer and a normal direction of the third light absorption anisotropic layer is more than 0° and 45° or less,
an average value AX of a transmittance of the first light absorption anisotropic layer in a direction along the transmittance central axis of the first light absorption anisotropic layer and a transmittance of the second light absorption anisotropic layer in a direction along the transmittance central axis of the second light absorption anisotropic layer is more than an average value AY of the transmittance of the second light absorption anisotropic layer in the direction along the transmittance central axis of the second light absorption anisotropic layer and a transmittance of the third light absorption anisotropic layer in a direction along the transmittance central axis of the third light absorption anisotropic layer,
the angle A3 is more than any of the angle A1 or the angle A2,
the first retardation layer has a function of changing a direction of linearly polarized light incident from a normal direction of the first retardation layer to a direction having an angle of 90°±10° with respect to the direction and emitting the incident light,
the second retardation layer has a function of changing a direction of linearly polarized light incident from a normal direction of the second retardation layer to a direction having an angle of 90°±10° with respect to the direction and emitting the incident light,
the first liquid crystal cell and the second liquid crystal cell are each independently a liquid crystal cell in a TN mode, a liquid crystal cell in a VA mode, a liquid crystal cell in an OCB mode, or a liquid crystal cell in an ECB mode,
the liquid crystal cell in the TN mode is a liquid crystal cell that rotates by 80° to 100° linearly polarized light incident into the liquid crystal cell in a case where a liquid crystal compound in the liquid crystal cell is twisted and aligned, and
all of the liquid crystal cell in the VA mode, the liquid crystal cell in the OCB mode, and the liquid crystal cell in the ECB mode are liquid crystal cells where an in-plane retardation at a wavelength of 550 nm is switchable between 0 to 20 nm and 250 to 300 nm.

(7) The optical laminate according to (6),
in which the first retardation layer and the second retardation layer are each independently selected from the group consisting of a retardation layer obtained by immobilizing a liquid crystal compound that is twisted and aligned along a helical axis extending along a thickness direction, a λ/2 plate, and a laminate where two λ/2 plates are laminated such that an angle between in-plane slow axes of the two λ/2 plates is in a range of 45°±10°.

(8) An image display apparatus comprising:
an image display element; and
the optical laminate according to any one of (1) to (7).

According to the present invention, it is possible to provide an optical laminate having the highest luminance in the vicinity of a front direction and having a luminance that is asymmetrical in a direction tilted from the front direction in a case where the optical laminate is applied to a light source.

In addition, according to the present invention, an image display apparatus can be provided.

### BRIEF DESCRIPTION OF THE DRAWINGS

FIG. 1 is a diagram showing an example of an optical laminate according to a first aspect of the present invention.

FIG. 2 is a view for describing the definition of a polar angle and an azimuthal angle.

FIG. 3 is a diagram showing a direction of a transmittance central axis of a second light absorption anisotropic layer.

FIG. 4 is a diagram showing a direction of a transmittance central axis of a third light absorption anisotropic layer.

FIG. 5 is a diagram showing a relationship between a polar angle and a luminance observed in a case where three layer portions including a first light absorption anisotropic layer 12A, a first retardation layer 14A, and a second light absorption anisotropic layer 16A are disposed on a light source.

FIG. 6 is a diagram showing a relationship between a polar angle and a luminance observed in a case where three layer portions including the second light absorption anisotropic layer 16A, a second retardation layer 18A, and a third light absorption anisotropic layer 20A are disposed on a light source.

FIG. 7 is a diagram showing a relationship between a polar angle and a luminance observed in a case where an optical laminate 10A is disposed on a light source.

FIG. 8 is a diagram showing an example of an optical laminate according to a second aspect of the present invention.

FIG. 9 is a diagram showing an example of an optical laminate according to a third aspect of the present invention.

### DESCRIPTION OF THE PREFERRED EMBODIMENTS

Hereinafter, the details of the present invention will be described.

The following description regarding configuration requirements has been made based on a representative embodiment of the present invention. However, the present invention is not limited to the embodiment.

In the present specification, a numerical range expressed using “to” refers to a range including numerical values described before and after “to” as a lower limit value and an upper limit value.

In addition, in the present specification, the terms parallel and orthogonal do not mean only strict parallel and strict orthogonal, respectively, but rather a range of parallel ±5° and a range of orthogonal ±5°, respectively.

In addition, in the present specification, materials that correspond to each of components may be used alone or in combination of two or more kinds. Here, in a case where two or more kinds of materials are used in combination for each of components, the content of the component refers to the total content of the materials to be combined unless specified otherwise.

In addition, in the present specification, “(meth)acrylate” represents “acrylate” or “methacrylate”, “(meth)acryl” represents “acryl” or “methacryl”, and “(meth)acryloyl” represents “acryloyl” or “methacryloyl”.

In addition, in the present specification, Re(λ) and Rth(λ) represent an in-plane-direction retardation and a thickness-direction retardation at a wavelength λ, respectively. Unless otherwise specified, the wavelength λ refers to 550 nm.

In the present invention, Re(λ) and Rth(λ) are values measured at the wavelength λ in AxoScan (manufactured by Axometrics, Inc.). By inputting an average refractive index ((nx+ny+nz)/3) and a film thickness (d (μm)) to AxoScan, the followings are calculated.

$$Slow Axis Direction ( ° )$$

$$Re ( λ ) = R 0 ( λ )$$

$$Rth ( λ ) = ( ( nx + ny ) / 2 - nz ) \times d$$

RO(λ) is expressed as a numerical value calculated by AxoScan and represents Re(λ).

In addition, in the present specification, the refractive indices nx, ny, and nz are measured using an Abbe refractometer (NAR-4T, manufactured by Atago Co., Ltd.), and a sodium lamp (λ=589 nm) is used as a light source. In addition, the wavelength dependence can be measured using a combination of a multi-wavelength Abbe refractometer DR-M2 (manufactured by Atago Co., Ltd.) and an interference filter.

In addition, as the refractive index, values described in “Polymer Handbook” (John Wiley&Sons, Inc.) and catalogs of various optical films can also be used. The values of average refractive index of major optical films are as follows: cellulose acylate (1.48), cycloolefin polymer (1.52), polycarbonate (1.59), polymethyl methacrylate (1.49), and polystyrene (1.59).

Optical laminate according to first to third aspects of the present invention have the highest luminance in the vicinity of a front direction and have a luminance that is asymmetrical in a left-right direction tilted from the front direction in a case where the optical laminate is disposed on a light source.

Hereinafter, each of the aspects will be described in detail.

### First Aspect

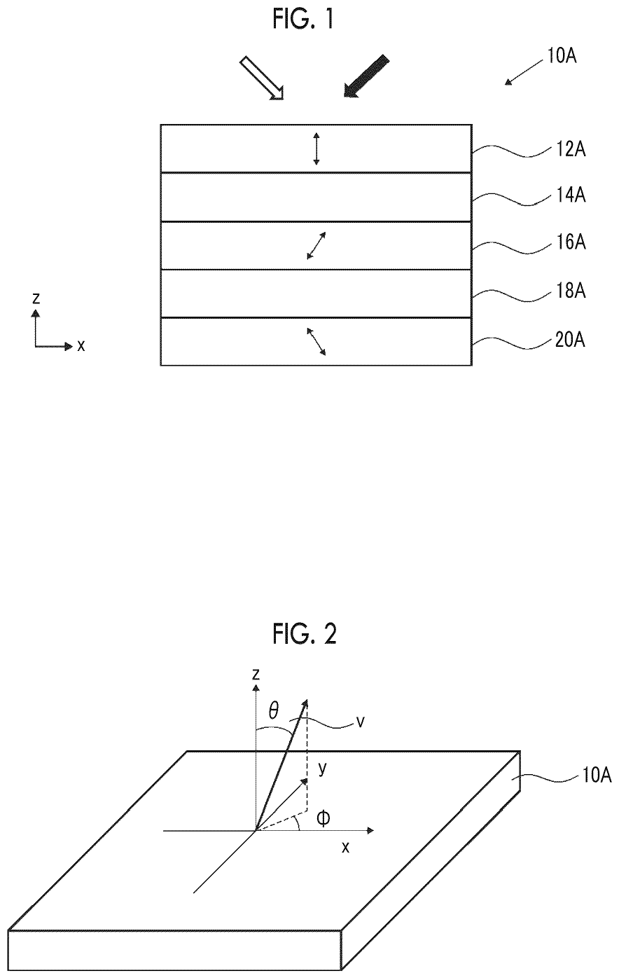

FIG. 1 shows an example of the optical laminate according to the first aspect of the present invention.

An optical laminate 10A shown in FIG. 1 includes a first light absorption anisotropic layer 12A, a first retardation layer 14A, a second light absorption anisotropic layer 16A, a second retardation layer 18A, and a third light absorption anisotropic layer 20A in this order. Hereinafter, first, a polar angle and an azimuthal angle will be described based on FIG. 2.

In FIG. 2, it is assumed that a plane (a main surface; a surface perpendicular to a thickness direction) of the optical laminate 10A is an xy plane. As shown in FIG. 2, an angle between a vector v and a z-axis is defined as a polar angle, and an angle φ between a projection of the vector v on the xy plane and an x-axis is defined as an azimuthal angle.

An arrow in the first light absorption anisotropic layer 12A shown in FIG. 1 indicates a transmittance central axis, and an angle between the transmittance central axis of the first light absorption anisotropic layer 12A and a normal direction of the first light absorption anisotropic layer 12A (in other words, a normal direction of the optical laminate 10A) is 0°.

An arrow in the second light absorption anisotropic layer 16A shown in FIG. 1 indicates a transmittance central axis, and the transmittance central axis of the second light absorption anisotropic layer 16A is tilted at a polar angle of 10° with respect to the normal direction of the second light absorption anisotropic layer 16A (in other words, the normal direction of the optical laminate 10A). The transmittance central axis of the second light absorption anisotropic layer 16A is tilted to the right side (clockwise) in FIG. 2 with respect to the normal direction.

An arrow in the third light absorption anisotropic layer 20A shown in FIG. 1 indicates a transmittance central axis, and the transmittance central axis of the third light absorption anisotropic layer 20A is tilted at a polar angle of 10° with respect to the normal direction of the third light absorption anisotropic layer 20A (in other words, the normal direction of the optical laminate 10A). The transmittance central axis of the third light absorption anisotropic layer 20A is tilted to the left side (counterclockwise) in FIG. 2 with respect to the normal direction.

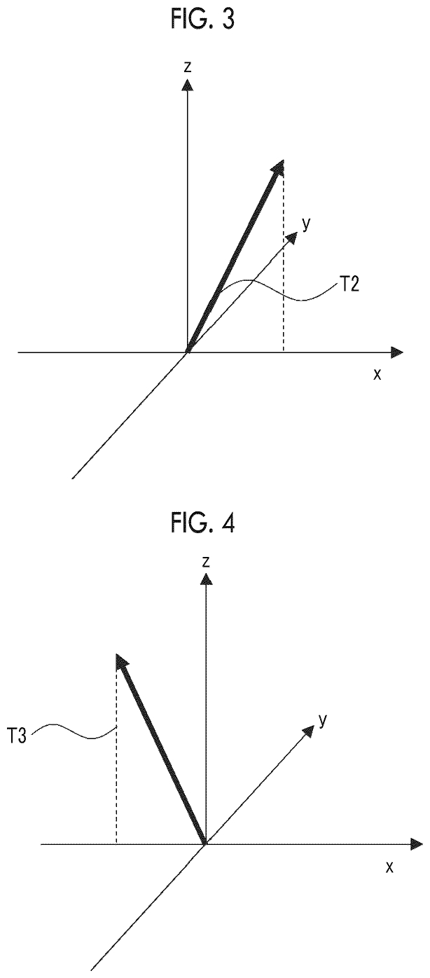

In addition, an angle between an orientation in an in-plane direction of the transmittance central axis of the second light absorption anisotropic layer 16A and an orientation in an in-plane direction of the transmittance central axis of the third light absorption anisotropic layer 20A is 180°. More specifically, the transmittance central axis T2 of the second light absorption anisotropic layer 16A is tilted at a predetermined angle along an x-axis direction (the right side direction on the paper plane of FIG. 1) as shown in FIG. 3, and the transmittance central axis T3 of the third light absorption anisotropic layer 20A is also tilted along the x-axis direction as shown in FIG. 4 but is tilted to an orientation (the left side direction on the paper plane of FIG. 1) opposite to the transmittance central axis T2. That is, an orientation of the transmittance central axis T2 of the second light absorption anisotropic layer 16A is the positive direction of the x-axis, an orientation of the transmittance central axis T3 of the third light absorption anisotropic layer 20A is the negative direction of the x-axis, and an angle between the two orientations is 180°.

The first retardation layer 14A and the second retardation layer 18A shown in FIG. 1 are layers that rotate by 90° linearly polarized light incident from the normal direction of the retardation layer. The first retardation layer 14A and the second retardation layer 18A are so-called optical rotation layers.

By using the optical laminate 10A having the above-described configuration, a mechanism with which a desired effect can be obtained will be described below.

First, a mechanism obtained by the three layers including the first light absorption anisotropic layer 12A, the first retardation layer 14A, and the second light absorption anisotropic layer 16A in the optical laminate 10A will be described.

In a case where light is incident from the normal direction of the optical laminate 10A into the three layer portions including the first light absorption anisotropic layer 12A, the first retardation layer 14A, and the second light absorption anisotropic layer 16A (case where light is incident from the upper side toward the lower side on the paper plane of FIG. 1), as described above, an angle between the transmittance central axis of the first light absorption anisotropic layer 12A and the normal direction of the first light absorption anisotropic layer 12A is 0°. Therefore, absorption of light by the first light absorption anisotropic layer 12A does not substantially occur.

Next, light transmitted through the first light absorption anisotropic layer 12A is incident into the first retardation layer 14A, and transmits in this polarization state as it is.

Next, in a case where the light transmitted through the first retardation layer 14A is incident into the second light absorption anisotropic layer 16A, the transmittance central axis of the second light absorption anisotropic layer 16A is tilted by 10° from the normal direction. Therefore, the transmittance central axis of the second light absorption anisotropic layer 16A can function as an absorption axis for the light incident into the second light absorption anisotropic layer 16A. Note that, since the tilt of the transmittance central axis is small, the amount of light absorbed is small, and most of the light incident into the second light absorption anisotropic layer 16A transmits as it is.

On the other hand, in a case where light is incident from a white arrow of FIG. 1 into the three layer portions including the first light absorption anisotropic layer 12A, the first retardation layer 14A, and the second light absorption anisotropic layer 16A, the transmittance central axis of the first light absorption anisotropic layer 12A can function as an absorption axis for the oblique incident light. In particular, as the tilt of the incident light from the normal direction increases, the transmittance central axis of the first light absorption anisotropic layer 12A can function as an absorption axis. Therefore, light transmitted through the first light absorption anisotropic layer 12A is light where the amount of linearly polarized light in a direction (front-depth direction on the paper plane of FIG. 1) orthogonal to the transmittance central axis of the first light absorption anisotropic layer 12A is large.

Next, in a case where the light transmitted through the first light absorption anisotropic layer 12A is incident into the first retardation layer 14A, the direction of the linearly polarized light in the direction orthogonal to the transmittance central axis of the first light absorption anisotropic layer 12A is rotated by 90°.

Next, in a case where the light transmitted through the first retardation layer 14A is incident into the second light absorption anisotropic layer 16A, the direction of the linearly polarized light rotated by the first retardation layer 14A overlaps the direction of the transmittance central axis of the second light absorption anisotropic layer 16A. Therefore, the transmittance central axis of the second light absorption anisotropic layer 16A functions as an absorption axis, and light incident into the second light absorption anisotropic layer 16A is absorbed. In particular, as the tilt of the incident light from the normal direction increases, the transmittance central axis of the second light absorption anisotropic layer 16A can function as an absorption axis.

In addition, in a case where light is incident from a black arrow of FIG. 1 into the three layer portions including the first light absorption anisotropic layer 12A, the first retardation layer 14A, and the second light absorption anisotropic layer 16A, the transmittance central axis of the first light absorption anisotropic layer 12A can function as an absorption axis for the oblique incident light. In particular, as the tilt of the incident light from the normal direction increases, the transmittance central axis of the first light absorption anisotropic layer 12A can function as an absorption axis. Therefore, light transmitted through the first light absorption anisotropic layer 12A is light where the amount of linearly polarized light in a direction (front-depth direction on the paper plane of FIG. 1) orthogonal to the transmittance central axis of the first light absorption anisotropic layer 12A is large.

Next, in a case where the light transmitted through the first light absorption anisotropic layer 12A is incident into the first retardation layer 14A, the direction of the linearly polarized light in the direction orthogonal to the transmittance central axis of the first light absorption anisotropic layer 12A is rotated by 90°.

Next, in a case where the light transmitted through the first retardation layer 14A is incident into the second light absorption anisotropic layer 16A, the direction of the linearly polarized light rotated by the first retardation layer 14A overlaps the direction of the transmittance central axis of the second light absorption anisotropic layer 16A. As in the case of the white arrow, the transmittance central axis of the second light absorption anisotropic layer 16A functions as an absorption axis, and light incident into the second light absorption anisotropic layer 16A is absorbed. However, in this case, the transmittance central axis of the second light absorption anisotropic layer 16A is tilted to the left side in FIG. 1. Therefore, the function as an absorption axis is weaker than that of the case of the white arrow. Therefore, absorption of incident light by the second light absorption anisotropic layer 16A is smaller than that of the case of the white arrow.

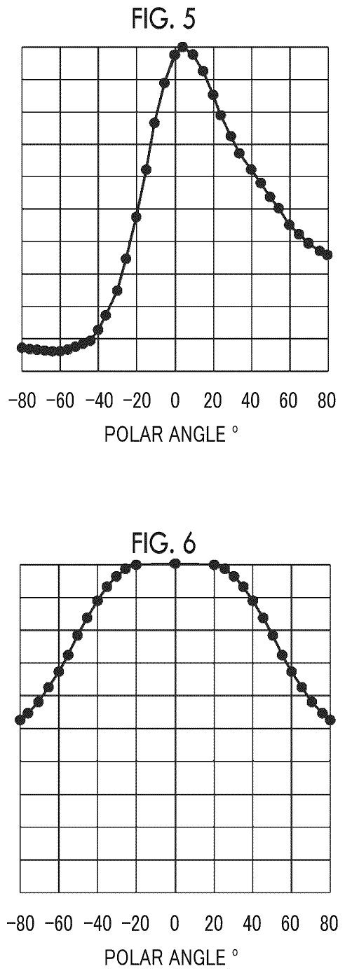

FIG. 5 shows an example of a relationship between a polar angle and a luminance observed in a case where the three layer portions including the first light absorption anisotropic layer 12A, the first retardation layer 14A, and the second light absorption anisotropic layer 16A are disposed on a light source. The light source is disposed on a side of the second light absorption anisotropic layer 16A opposite to the first retardation layer 14A side.

The horizontal axis of FIG. 5 represents the size of the polar angle between an observation direction and the normal direction of the first light absorption anisotropic layer 12A, a polar angle representing a positive numerical value represents a polar angle tilted to the right side as indicated by the black arrow of FIG. 1, and a polar angle representing a negative numerical value represents a polar angle tilted to the left side as indicated by the white arrow of FIG. 1. The polar angle tilted to the right side is a polar angle tilted along the orientation in the in-plane direction of the transmittance central axis of the second light absorption anisotropic layer 16A, and the polar angle tilted to the left side is a polar angle tilted along the orientation in the in-plane direction of the transmittance central axis of the third light absorption anisotropic layer 20A. In addition, the vertical axis of FIG. 5 represents a luminance.

As shown in FIG. 5, a luminance during observation of the vicinity of the front direction is higher than a luminance during observation from a direction tilted to the left side and a luminance during observation from a direction tilted to the right side. In addition, in a case where the luminance during observation from the direction tilted to the left side and the luminance during observation from the direction tilted to the right side are compared to each other, the luminance during observation from the direction tilted to the right side is higher in terms of an absolute value at the same polar angle. That is, the intensity of the luminance during observation in the left-right direction is asymmetrical.

The polar angle at which the luminance is the highest is a position of the polar angle on the more positive side further than 0°.

As described above, the luminance can switch between the value during the observation in the front direction and the value during the observation in the left-right direction due to the three layer portions including the first light absorption anisotropic layer 12A, the first retardation layer 14A, and the second light absorption anisotropic layer 16A.

Next, a mechanism obtained by the three layers including the second light absorption anisotropic layer 16A, the second retardation layer 18A, and the third light absorption anisotropic layer 20A in the optical laminate 10A will be described.

In a case where light is incident from the normal direction of the optical laminate 10A into the three layer portions including the second light absorption anisotropic layer 16A, the second retardation layer 18A, and the third light absorption anisotropic layer 20A (case where light is incident from the upper side toward the lower side on the paper plane of FIG. 1), the transmittance central axis of the second light absorption anisotropic layer 16A is tilted by 10° from the normal direction. Therefore, the transmittance central axis of the second light absorption anisotropic layer 16A can function as an absorption axis for the light incident into the second light absorption anisotropic layer 16A. Note that, since the tilt of the transmittance central axis is small, the amount of light absorbed is small, and most of the light incident into the second light absorption anisotropic layer 16A transmits as it is. Next, in a case where the light transmitted through the second light absorption anisotropic layer 16A is incident into the second retardation layer 18A, the direction of linearly polarized light of the incident light is rotated by 90°. For example, a direction of linearly polarized light in a direction (front-depth direction on the paper plane of FIG. 1) orthogonal to the transmittance central axis of the second light absorption anisotropic layer 16A is rotated by 90°.

Next, in a case where the light transmitted through the second retardation layer 18A is incident into the third light absorption anisotropic layer 20A, the direction of the linearly polarized light rotated by the second retardation layer 18A overlaps the direction of the transmittance central axis of the third light absorption anisotropic layer 20A. Therefore, the transmittance central axis of the third light absorption anisotropic layer 20A functions as an absorption axis, and a part of light incident into the third light absorption anisotropic layer 20A is absorbed. Note that, since the tilt of the transmittance central axis is small, the amount of light absorbed is small, and most of the light incident into the third light absorption anisotropic layer 20A transmits as it is.

That is, in a case where light is incident from the normal direction of the optical laminate 10A into the three layer portions including the second light absorption anisotropic layer 16A, the second retardation layer 18A, and the third light absorption anisotropic layer 20A, a part of the incident light is absorbed by the second light absorption anisotropic layer 16A and the third light absorption anisotropic layer 20A, but most of the incident light transmits as it is.

Next, a case where light tilted from the normal direction of the optical laminate 10A is incident into the three layer portions including the second light absorption anisotropic layer 16A, the second retardation layer 18A, and the third light absorption anisotropic layer 20A will be discussed.

First, in a case where light is incident from the white arrow of FIG. 1 into the three layer portions including the second light absorption anisotropic layer 16A, the second retardation layer 18A, and the third light absorption anisotropic layer 20A, the transmittance central axis of the second light absorption anisotropic layer 16A can function as an absorption axis for the oblique incident light. In particular, as the tilt of the incident light from the normal direction increases, the transmittance central axis of the second light absorption anisotropic layer 16A can function as an absorption axis. Therefore, light transmitted through the second light absorption anisotropic layer 16A is light where the amount of linearly polarized light in a direction (front-depth direction on the paper plane of FIG. 1) orthogonal to the transmittance central axis of the second light absorption anisotropic layer 16A is large.

Next, in a case where the light transmitted through the second light absorption anisotropic layer 16A is incident into the second retardation layer 18A, the direction of the linearly polarized light in the direction orthogonal to the transmittance central axis of the second light absorption anisotropic layer 16A is rotated by 90°.

Next, in a case where the light transmitted through the second retardation layer 18A is incident into the third light absorption anisotropic layer 20A, the direction of the linearly polarized light rotated by the second retardation layer 18A overlaps the direction of the transmittance central axis of the third light absorption anisotropic layer 20A. Therefore, the transmittance central axis of the third light absorption anisotropic layer 20A functions as an absorption axis, and light incident into the third light absorption anisotropic layer 20A is absorbed. In particular, as the tilt of the incident light from the normal direction increases, the transmittance central axis of the third light absorption anisotropic layer 20A can function as an absorption axis.

Even in a case where light tilted from the normal direction of the optical laminate 10A is incident from the black arrow of FIG. 1 into the three layer portions including the second light absorption anisotropic layer 16A, the second retardation layer 18A, and the third light absorption anisotropic layer 20A, absorption of the incident light occurs due to the same mechanism as described above.

FIG. 6 shows an example of a relationship between a polar angle and a luminance observed in a case where the three layer portions including the second light absorption anisotropic layer 16A, the second retardation layer 18A, and the third light absorption anisotropic layer 20A are disposed on a light source. The light source is disposed on a side of the third light absorption anisotropic layer 20A opposite to the second retardation layer 18A side.

The horizontal axis of FIG. 6 represents the size of the polar angle between an observation direction and the normal direction of the second light absorption anisotropic layer 16A, a polar angle representing a positive numerical value represents a polar angle tilted to the right side as indicated by the black arrow of FIG. 1, and a polar angle representing a negative numerical value represents a polar angle tilted to the left side as indicated by the white arrow of FIG. 1. The polar angle tilted to the right side is a polar angle tilted along the orientation in the in-plane direction of the transmittance central axis of the second light absorption anisotropic layer 16A, and the polar angle tilted to the left side is a polar angle tilted along the orientation in the in-plane direction of the transmittance central axis of the third light absorption anisotropic layer 20A. In addition, the vertical axis of FIG. 6 represents a luminance.

As shown in FIG. 6, a luminance during observation of the vicinity of the front direction is higher than a luminance during observation from a direction tilted to the left side and a luminance during observation from a direction tilted to the right side. In addition, in this case, a state where the luminance is high in a wide range in the vicinity of the front direction is achieved.

In addition, in a case where the luminance during observation from the direction tilted to the left side and the luminance during observation from the direction tilted to the right side are compared to each other, the same luminance is exhibited in terms of an absolute value at the same polar angle. That is, the intensity of the luminance during observation in the left-right direction is symmetrical.

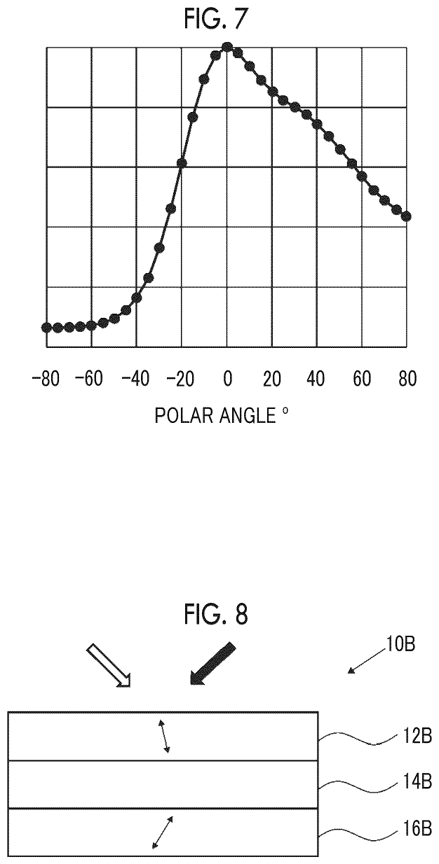

The optical laminate 10A includes a combination of the function by the three layer portions including the first light absorption anisotropic layer 12A, the first retardation layer 14A, and the second light absorption anisotropic layer 16A described in FIG. 5 and the function by the three layer portions including the second light absorption anisotropic layer 16A, the second retardation layer 18A, and the third light absorption anisotropic layer 20A described in FIG. 6. More specifically, FIG. 7 shows an example of a relationship between a polar angle and a luminance observed in a case where the optical laminate 10A is disposed on a light source. The light source is disposed on a side of the third light absorption anisotropic layer 20A opposite to the second retardation layer 18A side.

As shown in FIG. 7, a luminance during observation in the front direction is higher than a luminance during observation from a direction tilted to the left side and a luminance during observation from a direction tilted to the right side. As described above, in FIG. 5, the observation direction in which the luminance is the highest is shifted from 0°. In the optical laminate 10A, the luminance is the highest at a polar angle of 0°.

In addition, in a case where the luminance during observation from the direction tilted to the left side and the luminance during observation from the direction tilted to the right side are compared to each other, the luminance during observation from the direction tilted to the right side is higher in terms of an absolute value at the same polar angle. That is, the intensity of the luminance during observation in the left-right direction is asymmetrical.

As described above, it can be seen that the optical laminate 10A exhibits the desired effect.

In FIG. 1, the aspect where the first retardation layer and the second retardation layer are used has been described. However, a first liquid crystal cell described below may also be used instead of the first retardation layer, and a second liquid crystal cell described below may also be used instead of the second retardation layer.

In a case where the first liquid crystal cell is used instead of the first retardation layer, a switching function can be imparted to the optical laminate. That is, retardation characteristics of the first liquid crystal cell can change by switching on and off the power of the first liquid crystal cell. As a result, the optical laminate can switch between a case where the function of the optical laminate is exhibited and a case where the function of the optical laminate is not exhibited.

Even in a case where the second liquid crystal cell is used instead of the second retardation layer, a switching function can be imparted to the optical laminate. That is, retardation characteristics of the second liquid crystal cell can change by switching on and off the power of the second liquid crystal cell. As a result, the optical laminate can switch between a case where the function of the optical laminate is exhibited and a case where the function of the optical laminate is not exhibited.

In addition, the angles of the transmittance central axes of the first light absorption anisotropic layer, the second light absorption anisotropic layer, and the third light absorption anisotropic layer are not limited to the aspect of FIG. 1, and may be positioned in predetermined ranges described below.

Hereinafter, each of the members in the optical laminate according to the first aspect of the present invention will be described in detail.

### <First Light Absorption Anisotropic Layer>

The first light absorption anisotropic layer has the transmittance central axis.

Here, the transmittance central axis refers to a direction in which the transmittance is the highest in a case where the transmittance is measured while changing a polar angle and an azimuthal angle with respect to the normal direction of the light absorption anisotropic layer surface.

Specifically, the Mueller matrix at a wavelength of 550 nm is measured using AxoScan OPMF-2 (manufactured by Axometrics, Inc.). More specifically, in the measurement, an azimuthal angle at which the transmittance central axis is tilted is first searched for, the Mueller matrix at a wavelength of 550 nm is measured while changing the polar angle which is the angle with respect to the normal direction of the surface of the light absorption anisotropic layer from −70° to 70° at intervals of 1° in the surface (the plane that has the transmittance central axis and is orthogonal to the layer surface) having the normal direction of the light absorption anisotropic layer along the azimuthal angle, and the transmittance of the light absorption anisotropic layer is derived. As a result, the direction in which the transmittance is the highest is defined as the transmittance central axis.

The transmittance central axis is also an absorption axis of the light absorption anisotropic layer, and in a case where the light absorption anisotropic layer includes a dichroic substance described below, and is likely to correspond to a direction (major axis direction of a molecule) of an absorption axis of the dichroic substance that is aligned. As described above, in a case where light is incident from a direction tilted with respect to the transmittance central axis, the transmittance central axis can function as an absorption axis.

In the first light absorption anisotropic layer, an angle A1 between the transmittance central axis of the first light absorption anisotropic layer and the normal direction of the first light absorption anisotropic layer is 0° to 45°. In particular, from the viewpoint of further increasing the luminance in the front direction in a case where the optical laminate is disposed on a light source, the angle A1 is preferably 0° to 35°, more preferably 0° to 25°, still more preferably 0° to 15°, still more preferably 0° or more and less than 10°, and most preferably 0° or more and less than 5°.

The thickness of the first light absorption anisotropic layer is not particularly limited, and is preferably 0.5 to 7 μm and more preferably 0.5 to 5 μm.

A material for forming the first light absorption anisotropic layer is not particularly limited and preferably includes a dichroic substance and a liquid crystal compound. The liquid crystal compound in the first light absorption anisotropic layer may be a cured substance of a liquid crystal compound having a polymerizable group. The dichroic substance in the first light absorption anisotropic layer may be a cured substance of a dichroic substance having a polymerizable group.

In particular, it is preferable that the first light absorption anisotropic layer is a layer formed of a composition including a dichroic substance and a liquid crystal compound (composition for forming a light absorption anisotropic layer).

In addition, the composition may include a solvent, a polymerization initiator, a polymerizable compound, an interface improver, and other additives.

Hereinafter, each of the components will be described.

### (Dichroic Substance)

The dichroic substance refers to a coloring agent having different absorbances depending on directions. The dichroic substance may be immobilized in the first light absorption anisotropic layer.

The dichroic substance is a substance exhibiting dichroism, and the dichroism denotes a property in which an absorbance varies depending on the polarization direction.

The dichroic substance is not particularly limited, and examples thereof include a visible light absorption material (dichroic coloring agent), a light emitting material (such as a fluorescent material or a phosphorescent material), an ultraviolet absorbing material, an infrared absorbing material, a non-linear optical material, a carbon nanotube, and an inorganic material (for example, a quantum rod). In addition, well-known dichroic substances (preferably, dichroic coloring agents) of the related art can be used.

The dichroic substance may have a polymerizable group. By forming the light absorption anisotropic layer using the above-described composition including the dichroic substance having a polymerizable group, the dichroic substance can be immobilized by polymerization.

As the dichroic substance, a dichroic azo coloring agent compound is preferable.

The dichroic azo coloring agent compound refers to an azo coloring agent compound having different absorbances depending on directions. The dichroic azo coloring agent compound may or may not exhibit liquid crystallinity. In a case where the dichroic azo coloring agent compound exhibits liquid crystallinity, the dichroic azo coloring agent compound may exhibit any of nematic liquid crystallinity or smectic liquid crystallinity. A temperature range where a liquid crystal phase is exhibited is preferably room temperature (about 20° C. to 28° C.) to 300° C. and more preferably 50° C. to 200° C. from the viewpoints of handleability and manufacturing suitability.

In the present invention, from the viewpoint of adjusting the tint, it is preferable that at least one coloring agent compound (hereinafter, abbreviated as a first dichroic azo coloring agent compound) having a maximal absorption wavelength in a wavelength range of 560 to 700 nm and at least one coloring agent compound (hereinafter, abbreviated as a second dichroic azo coloring agent compound) having a maximal absorption wavelength in a wavelength range of 455 nm or more and less than 560 nm are at least used.

In the present invention, three or more kinds of dichroic azo coloring agent compounds may be used in combination. For example, from the viewpoint of approximating the light absorption anisotropic layer to black, it is preferable that the first dichroic azo coloring agent compound, the second dichroic azo coloring agent compound, and at least one coloring agent compound having a maximal absorption wavelength in a wavelength range of 380 nm or more and less than 455 nm are used in combination.

In the present invention, it is preferable that the dichroic azo coloring agent compound has a polymerizable group.

Examples of the polymerizable group include a (meth)acryloyl group, an epoxy group, an oxetanyl group, and a styryl group. Among these, a (meth)acryloyl group is preferable.

A content of the dichroic substance is preferably 1% to 30% by mass, more preferably 5% to 25% by mass, and still more preferably 10% to 20% by mass with respect to the total solid content mass of the first light absorption anisotropic layer.

### (Liquid Crystal Compound)

As the liquid crystal compound, both a polymer liquid crystal compound and a low-molecular-weight liquid crystal compound can be used, and from the viewpoint of increasing the alignment degree, a polymer liquid crystal compound is preferable. In addition, the polymer liquid crystal compound and the low-molecular-weight liquid crystal compound may be used in combination as the liquid crystal compound. The liquid crystal compound may be immobilized in the light absorption anisotropic layer.

Here, “polymer liquid crystal compound” refers to a liquid crystal compound including a repeating unit in a chemical structure.

In addition, “low-molecular-weight liquid crystal compound” refers to a liquid crystal compound not including a repeating unit in a chemical structure.

The low-molecular-weight liquid crystal compound may be a compound exhibiting a nematic liquid crystal phase or a compound exhibiting a smectic liquid crystal phase, but from the viewpoint of increasing the alignment degree, a compound exhibiting a smectic liquid crystal phase is preferable. Examples thereof include liquid crystal compounds described in JP2013-228706A.

Examples of the polymer liquid crystal compound include thermotropic liquid crystal polymers described in JP2011-237513A. In addition, from the viewpoint of enhancing a strength (particularly, bend resistance of the film), it is preferable that the polymer liquid crystal compound has a repeating unit having a crosslinkable group at the terminal. Examples of the crosslinkable group include polymerizable groups described in paragraphs to of JP2010-244038A. Among these, from the viewpoint of improving reactivity and synthetic suitability, an acryloyl group, a methacryloyl group, an epoxy group, an oxetanyl group, or a styryl group is preferable, and an acryloyl group or a methacryloyl group is more preferable. The crosslinkable group may be a polymerizable group.

In a case where the first light absorption anisotropic layer includes the polymer liquid crystal compound, it is preferable that the polymer liquid crystal compound forms a nematic liquid crystal phase. A temperature range at which the nematic liquid crystal phase is exhibited is preferably room temperature (23° C.) to 450° C., and more preferably 50° C. to 400° C. from the viewpoint of handleability and manufacturing suitability.

A content of a component derived from the liquid crystal compound in the first light absorption anisotropic layer is preferably 25 to 2000 parts by mass, more preferably 100 to 1300 parts by mass, and still more preferably 200 to 900 parts by mass with respect to 100 parts by mass of the content of the dichroic substance. In a case where the content of the liquid crystal compound is within the above-described range, the alignment degree of the dichroic substance is further improved.

The light absorption anisotropic layer may include one kind of a liquid crystal compound alone or may include two or more kinds of liquid crystal compounds. In a case where the light absorption anisotropic layer includes two or more kinds of liquid crystal compounds, the above-described content of the component derived from the liquid crystal compound refers to the total content of the liquid crystal compounds.

### (Additives)

The liquid crystal composition used for forming the first light absorption anisotropic layer may further include an additive such as a solvent, a vertical alignment agent, an interface improver, a leveling agent, a polymerizable component, a polymerization initiator (for example, a radical polymerization initiator), and a durability improver. Well-known additives can be appropriately used as the additive.

A method of forming the first light absorption anisotropic layer is not particularly limited, and examples thereof include a method including, in the following order, a step of applying a composition for forming a light absorption anisotropic layer to form a coating film (hereinafter, also referred to as “coating film forming step”) and a step of aligning a liquid crystal component or a dichroic substance in the coating film (hereinafter, also referred to as “alignment step”).

The liquid crystal component is a component including the above-described liquid crystal compound and, in a case where the above-described dichroic substance has liquid crystallinity, further includes a dichroic substance having liquid crystallinity.

### -Coating Film Forming Step-

The coating film forming step is a step of applying the composition for forming a light absorption anisotropic layer to form a coating film.

The composition for forming a light absorption anisotropic layer can be easily applied by using the composition for forming a light absorption anisotropic layer which contains the above-described solvent or using a liquid such as a melt obtained by heating the composition for forming a light absorption anisotropic layer.

Specific examples of the method of applying the composition for forming a light absorption anisotropic layer include well-known methods such as a roll coating method, a gravure printing method, a spin coating method, a wire bar coating method, an extrusion coating method, a direct gravure coating method, a reverse gravure coating method, a die-coating method, a spraying method, and an ink jet method.

### -Alignment Step-

The alignment step is a step of aligning the liquid crystal component in the coating film. As a result, the first light absorption anisotropic layer is obtained.

The alignment step may include a drying treatment. Through the drying treatment, a component such as the solvent may be removed from the coating film. The drying treatment may be performed using a method (for example, natural drying) of leaving the coating film to stand at room temperature for a predetermined time, or may be performed a method of performing heating and/or blowing.

Here, the liquid crystal component in the composition for forming a light absorption anisotropic layer may be aligned through the coating film forming step or the drying treatment described above. For example, in an aspect in which the composition for forming a light absorption anisotropic layer is prepared as a coating liquid including a solvent, a coating film having light absorption anisotropy (that is, the first light absorption anisotropic layer) is obtained by drying the coating film and removing the solvent from the coating film.

In a case where the drying treatment is performed at a temperature equal to or higher than a temperature of transition of the liquid crystal component in the coating film from a liquid crystal phase to an isotropic phase, a heating treatment described below may not be performed.

The transition temperature of the liquid crystal component in the coating film from a liquid crystal phase to an isotropic phase is preferably 10° C. to 250° C. and more preferably 25° C. to 190° C. from the viewpoints of manufacturing suitability and the like. It is preferable that the transition temperature is 10° C. or higher from the viewpoint that a cooling treatment or the like for lowering the temperature to a temperature range in which the liquid crystal phase is exhibited is not necessary. In addition, it is preferable that the transition temperature is 250° C. or lower from the viewpoint that, even in a case where the coating film is heated to the isotropic phase in order to suppress alignment defects, a high temperature is not required and waste of thermal energy and deformation and deterioration of the substrate can be reduced.

It is preferable that the alignment step includes a heating treatment. As a result, since the liquid crystal component in the coating film can be aligned, the heated coating film can be suitably used as the light absorption anisotropic layer.

The heating temperature is preferably in 10° C. to 250° C. and more preferably 25° C. to 190° C. from the viewpoint of manufacturing suitability. In addition, the heating time is preferably 1 to 300 seconds and more preferably 1 to 60 seconds.

The alignment step may include a cooling treatment that is performed after the heating treatment. In the cooling treatment, the heated coating film is cooled up to about room temperature (20° C. to 25° C.). As a result, the alignment of the liquid crystal component in the coating film can be immobilized. A cooling unit is not particularly limited, and a well-known method can be used.

### -Other Steps-

The method of forming the first light absorption anisotropic layer may include a step of curing the first light absorption anisotropic layer after the above-described alignment step (hereinafter, also referred to as “curing step”).

For example, in a case where the compound in the first light absorption anisotropic layer has a polymerizable group, the curing step is performed by heating and/or light irradiation (exposure). In particular, it is preferable that the curing step is performed by light irradiation from the viewpoint of productivity.

As a light source used for curing, various light sources for infrared light, visible light, ultraviolet light, or the like can be used, but a light source for ultraviolet light is preferable. In addition, during curing, the composition may be irradiated with ultraviolet light while being heated, or may be irradiated with ultraviolet light through a filter that allows transmission of light having a specific wavelength.

In a case where the exposure is performed while heating the first light absorption anisotropic layer, the heating temperature during the exposure preferably 25° C. to 140° C. although depending on the transition temperature of the liquid crystal component in the liquid crystal film.

In addition, the exposure may be performed in a nitrogen atmosphere. In a case where the curing of the liquid crystal film proceeds by radical polymerization, since inhibition of polymerization by oxygen is reduced, it is preferable that the exposure is performed in a nitrogen atmosphere.

A method of adjusting a tilt direction of the transmittance central axis of the first light absorption anisotropic layer is not particularly limited and, for example, a well-known method can be used. For example, by applying the composition for forming a light absorption anisotropic layer to a predetermined alignment film, a method of adjusting the tilt of the transmittance central axis can be used. Examples of the alignment film to be used include a hybrid alignment film that is formed using a liquid crystal compound. By adjusting the tilt angle of the liquid crystal compound on the surface of the hybrid alignment film, the tilt of a liquid crystal compound in a light absorption anisotoropic layer formed on the hybrid alignment film can be controlled to adjust the tilt direction (tilt angle) of the transmittance central axis.

### <Second Light Absorption Anisotropic Layer>

The second light absorption anisotropic layer has the transmittance central axis.

In the second light absorption anisotropic layer, an angle A2 between the transmittance central axis of the second light absorption anisotropic layer and the normal direction of the second light absorption anisotropic layer is more than 0° and 45° or less. In particular, from the viewpoint that the luminance in a direction tilted from the front direction is more asymmetrical in a case where the optical laminate is disposed on a light source, the angle A2 is preferably 5° to 35°, more preferably 5° to 25°, and still more preferably 5° to 15°.

The thickness of the second light absorption anisotropic layer is not particularly limited, and is preferably 0.5 to 7 μm and more preferably 0.5 to 5 μm.

A material for forming the second light absorption anisotropic layer is not particularly limited, and examples thereof include the above-described material for forming the first light absorption anisotropic layer.

Examples of a method of manufacturing the second light absorption anisotropic layer include the above-described method of manufacturing the first light absorption anisotropic layer.

### <Third Light Absorption Anisotropic Layer>

The third light absorption anisotropic layer has the transmittance central axis.

In the third light absorption anisotropic layer, an angle A3 between the transmittance central axis of the third light absorption anisotropic layer and the normal direction of the third light absorption anisotropic layer is more than 0° and 45° or less. In particular, from the viewpoint that the luminance in a direction tilted from the front direction is more asymmetrical in a case where the optical laminate is disposed on a light source, the angle A3 is preferably 5° to 35°, more preferably 5° to 25°, and still more preferably 5° to 15°.

The thickness of the third light absorption anisotropic layer is not particularly limited, and is preferably 0.5 to 7 μm and more preferably 0.5 to 5 μm.

A material for forming the third light absorption anisotropic layer is not particularly limited, and examples thereof include the above-described material for forming the first light absorption anisotropic layer.

Examples of a method of manufacturing the third light absorption anisotropic layer include the above-described method of manufacturing the first light absorption anisotropic layer.

### <Relationship Between First Light Absorption Anisotropic Layer, Second Light Absorption Anisotropic Layer, and Third Light Absorption Anisotropic Layer>

In the optical laminate according to the first aspect, the transmittance central axis of the first light absorption anisotropic layer and the transmittance central axis of the second light absorption anisotropic layer are not parallel to each other. As described above, in the present specification, being parallel does not represent parallel in a strict sense but represents a range of parallel ±5°. Accordingly, the above description represents that the angle between the transmittance central axis of the first light absorption anisotropic layer and the transmittance central axis of the second light absorption anisotropic layer is not within 5°. In other words, the above description represents that the angle between the transmittance central axis of the first light absorption anisotropic layer and the transmittance central axis of the second light absorption anisotropic layer is more than 5°.

In addition, an angle between an orientation in an in-plane direction of the transmittance central axis of the second light absorption anisotropic layer and an orientation in an in-plane direction of the transmittance central axis of the third light absorption anisotropic layer is 180°±20°. That is, the above-described angle is in a range of 160° to 200°. In particular, from the viewpoint that the luminance in a direction tilted from the front direction is more asymmetrical in a case where the optical laminate is disposed on a light source, the above-described angle is preferably 180°±10° and more preferably 180°±5°.

In the present specification, in a case where the orientation in the in-plane direction of the transmittance central axis of the light absorption anisotropic layer is acquired, a direction in which the transmittance central axis extends is specified with respect to the surface of the light absorption anisotropic layer opposite to the observation side.

For example, in a case where the second light absorption anisotropic layer is observed from the first light absorption anisotropic layer side, the orientation in the in-plane direction of the transmittance central axis of the second light absorption anisotropic layer refers to an orientation in the in-plane direction of the second light absorption anisotropic layer in which the transmittance central axis extends (is present) with respect to the surface of the second light absorption anisotropic layer opposite to the first light absorption anisotropic layer side. For example, in the second light absorption anisotropic layer 16A in the optical laminate 10A shown in FIG. 1, as shown in FIGS. 1 and 3, the transmittance central axis extends in the positive direction of the x-axis with respect to the surface of the second light absorption anisotropic layer opposite to the first light absorption anisotropic layer side. Accordingly, the orientation in the in-plane direction of the transmittance central axis in this case corresponds to the positive direction of the x-axis.

For example, in a case where the third light absorption anisotropic layer is observed from the first light absorption anisotropic layer side, the orientation in the in-plane direction of the transmittance central axis of the third light absorption anisotropic layer refers to an orientation in the in-plane direction of the third light absorption anisotropic layer in which the transmittance central axis extends (is present) with respect to the surface of the third light absorption anisotropic layer opposite to the first light absorption anisotropic layer side. For example, in the third light absorption anisotropic layer 20A in the optical laminate 10A shown in FIG. 1, as shown in FIGS. 1 and 4, the transmittance central axis extends in the negative direction of the x-axis with respect to the surface of the third light absorption anisotropic layer opposite to the first light absorption anisotropic layer side. Accordingly, the orientation in the in-plane direction of the transmittance central axis in this case corresponds to the negative direction of the x-axis.

An absolute value of a difference between the angle A2 between the transmittance central axis of the second light absorption anisotropic layer and the normal direction of the second light absorption anisotropic layer and the angle A3 between the transmittance central axis of the third light absorption anisotropic layer and the normal direction of the third light absorption anisotropic layer is not particularly limited, and is preferably 20° or less, more preferably 10° or less, and still more preferably 8° or less from the viewpoint that the luminance in a direction tilted from the front direction is more asymmetrical in a case where the optical laminate is disposed on a light source. The lower limit is not particularly limited and, for example, 0.

An absolute value of a difference between the angle A1 between the transmittance central axis of the first light absorption anisotropic layer and the normal direction of the first light absorption anisotropic layer and the angle A2 between the transmittance central axis of the second light absorption anisotropic layer and the normal direction of the second light absorption anisotropic layer is not particularly limited, and is preferably 5° or more and more preferably 10° or more from the viewpoint that the luminance in a direction tilted from the front direction is more asymmetrical in a case where the optical laminate is disposed on a light source. The upper limit is not particularly limited and is preferably 30° or less and more preferably 20° or less.

In a case where the angle A1 and the angle A2 are compared to each other, the angle A2 is preferably larger.

In a case where the angle A2 and the angle A3 are compared to each other, the angle A3 is preferably larger.

### <First Retardation Layer>

The first retardation layer has a function of changing a direction of linearly polarized light incident from the normal direction of the first retardation layer to a direction having an angle of 90°±10° with respect to the direction and emitting the incident light. In other words, an angle between a direction of linearly polarized light of light incident into the first retardation layer and a direction of linearly polarized light of light transmitted through the first retardation layer is 90°±10°.

The configuration of the first retardation layer is not particularly limited as long as it has the above-described function, and examples thereof include a retardation layer obtained by immobilizing a liquid crystal compound that is twisted and aligned along a helical axis extending along a thickness direction, a λ/2 plate, and a laminate where two λ/2 plates are laminated such that an angle between in-plane slow axes of the two λ/2 plates is in a range of 45°±10°.

The retardation layer obtained by immobilizing the liquid crystal compound that is twisted and aligned along the helical axis extending along the thickness direction is a so-called optical rotation layer. The optical rotation layer is an optical element having optical rotation. Having optical rotation represents that linearly polarized light rotates and propagates in a medium substantially without any change from linearly polarized light. Accordingly, the above-described retardation layer has a function of rotating by 80° to 100° linearly polarized light vertically incident into an in-plane of the retardation layer.

A twisted angle of the liquid crystal compound in the retardation layer is not particularly limited and is preferably 80° to 100°. As a method of measuring the twisted angle, is measured using Axoscan OPMF-2 (manufactured by Axometrics, Inc.) and using device analysis software of Axometrics, Inc.

Δnd of the retardation layer is not particularly limited and is preferably 350 to 600 nm and more preferably 400 to 500 nm.

Δn represents a refractivity anisotropy of the retardation layer at a wavelength of 550 nm, and d represents the thickness (nm) of the retardation layer.

The λ/2 plate refers to a retardation layer where an in-plane retardation is about ½ of the wavelength, and specifically refers to a retardation layer where an in-plane retardation Re(550) at a wavelength 550 nm is 220 to 320 nm.

In a case where an angle between linearly polarized light incident into the λ/2 plate and an in-plane slow axis of the λ/2 plate is 45°, an angle between the linearly polarized light incident into the λ/2 plate and linearly polarized light emitted from the λ/2 plate is 90°. Therefore, in a case where the λ/2 plate is used as the first retardation layer, the angle between the linearly polarized light incident into the λ/2 plate and the in-plane slow axis of the λ/2 plate is preferably 45°±10°.

The laminate where two λ/2 plates are laminated such that an angle between in-plane slow axes of the two λ/2 plates is in a range of 45°±10° is obtained by attaching two λ/2 plates at a predetermined angle.

The laminate includes two λ/2 plates, and the angle between the in-plane slow axes thereof is in a range of 45°±10°.

### <Second Retardation Layer>

The second retardation layer has a function of changing a direction of linearly polarized light incident from the normal direction of the second retardation layer to a direction having an angle of 90°±10° with respect to the direction and emitting the incident light. In other words, an angle between a direction of linearly polarized light of light incident into the second retardation layer and a direction of linearly polarized light of light transmitted through the second retardation layer is 90°±10°.

Examples of the second retardation layer include the above-described layers exemplified regarding first retardation layer.

### <First Liquid Crystal Cell>

The first liquid crystal cell is a liquid crystal cell in a TN mode, a liquid crystal cell in a VA mode, a liquid crystal cell in an OCB mode, or a liquid crystal cell in an ECB mode.

The liquid crystal cell in the TN mode refers to a liquid crystal cell where the alignment state of a liquid crystal compound in the liquid crystal cell can switch between vertical alignment and twisted alignment by switching on and off the voltage.

The twisted alignment refers to alignment where the liquid crystal compound is twisted stepwise along a helical axis extending in a thickness direction of the liquid crystal cell.

The liquid crystal cell in the TN mode rotates by 80° to 100° linearly polarized light incident from the normal direction of the liquid crystal cell into the liquid crystal cell in a case where the liquid crystal compound in the liquid crystal cell is twisted and aligned. That is, in a case where the liquid crystal compound in the liquid crystal cell is twisted and aligned, the same function as that of the optical rotation layer exemplified as the above-described first retardation layer is exhibited.

In the above-described liquid crystal cell in the TN mode, in a case where the liquid crystal compound is twisted and aligned, a twisted angle of the liquid crystal compound is not particularly limited and is preferably 80° to 100°.

In a case where the liquid crystal compound in the liquid crystal cell in the TN mode is vertically aligned, an in-plane retardation Re(550) of the liquid crystal cell at a wavelength of 550 nm is preferably 10 nm or less.

The liquid crystal cell in the VA mode refers to a liquid crystal cell where the alignment state of a liquid crystal compound in the liquid crystal cell can switch between vertical alignment and horizontal alignment by switching on and off the voltage.

The liquid crystal cell in the VA mode is a liquid crystal cell where an in-plane retardation at a wavelength of 550 nm is switchable between 0 to 20 nm and 250 to 300 nm. That is, the liquid crystal cell in the VA mode is switchable between a state where an in-plane retardation at a wavelength of 550 nm is in a range of 0 to 20 nm and a state where an in-plane retardation at a wavelength of 550 nm is in a range of 250 to 300 nm.

The liquid crystal cell in the OCB mode refers to a liquid crystal cell where the alignment state of a liquid crystal compound in the liquid crystal cell can switch between splay alignment and bend alignment by switching on and off the voltage.

As in the liquid crystal cell in the VA mode, the liquid crystal cell in the OCB mode is also a liquid crystal cell where an in-plane retardation at a wavelength of 550 nm is switchable between 0 to 20 nm and 250 to 300 nm.

The liquid crystal cell in the ECB mode refers to a liquid crystal cell where the alignment state of a liquid crystal compound in the liquid crystal cell can switch between vertical alignment and horizontal alignment by switching on and off the voltage.

As in the liquid crystal cell in the VA mode, the liquid crystal cell in the ECB mode is a liquid crystal cell where an in-plane retardation at a wavelength of 550 nm is switchable between 0 to 20 nm and 250 to 300 nm.

### <Other Members>

The optical laminate may include members other than the above-described various members (the first light absorption anisotropic layer to the third light absorption anisotropic layer, the first retardation layer and second retardation layer, and the first liquid crystal cell and the second liquid crystal cell).

Examples of the other members include a bonding layer such as an adhesive layer and a pressure-sensitive adhesive layer.

As an adhesive used for the adhesive layer and a pressure sensitive adhesive used for the pressure-sensitive adhesive layer, a well-known material can be used.

Examples of the other members include an alignment film. The alignment film may be a photo-alignment film.

The alignment film that is used is not particularly limited, and examples thereof include a well-known alignment film.

Examples of the other members include a support.

The support is a member for supporting various materials. As the support, a well-known support may be used, and a resin support is preferable. Examples of the resin support include a cellulose acylate film (such as a cellulose triacetate film (refractive index: 1.48), a cellulose diacetate film, a cellulose acetate butyrate film, or a cellulose acetate propionate film), a polyethylene terephthalate film, a polyether sulfone film, a polyacrylic resin film, a polyurethane-based resin film, a polyester film, a polycarbonate film, a polysulfone film, and a polyether film.

The thickness of the support is not particularly limited and is preferably 10 to 100 μm.

Examples of the other members include an oxygen blocking layer.

### <Method of Manufacturing Optical Laminate>

A method of manufacturing the optical laminate is not particularly limited, and examples thereof include a method of preparing the above-described various members and laminating the members through a bonding layer or the like.

### Second Aspect

FIG. 8 shows an example of the optical laminate according to the second aspect of the present invention.

An optical laminate 10B shown in FIG. 8 includes a first light absorption anisotropic layer 12B, a retardation layer 14B, and a second light absorption anisotropic layer 16B in this order.

An arrow in the first light absorption anisotropic layer 12B shown in FIG. 8 indicates a transmittance central axis, and the transmittance central axis of the first light absorption anisotropic layer 12B is tilted at a polar angle of 5° with respect to the normal direction of the first light absorption anisotropic layer 12B (in other words, the normal direction of the optical laminate 10B). The transmittance central axis of the first light absorption anisotropic layer 12B is tilted to the left side (counterclockwise) in FIG. 8 with respect to the normal direction.

An arrow in the second light absorption anisotropic layer 16B shown in FIG. 8 indicates a transmittance central axis, and the transmittance central axis of the second light absorption anisotropic layer 16B is tilted at a polar angle of 20° with respect to the normal direction of the second light absorption anisotropic layer 16B (in other words, the normal direction of the optical laminate 10B). The transmittance central axis of the second light absorption anisotropic layer 16B is tilted to the right side (clockwise) in FIG. 8 with respect to the normal direction.

In addition, an angle between an orientation in an in-plane direction of the transmittance central axis of the first light absorption anisotropic layer 12B and an orientation in an in-plane direction of the transmittance central axis of the second light absorption anisotropic layer 16B is 180°.

The retardation layer 14B shown in FIG. 8 is a layer that rotates by 90° linearly polarized light incident from the normal direction of the retardation layer. The retardation layer 14B is a so-called optical rotation layer.

By using the optical laminate 10B having the above-described configuration, a mechanism with which a desired effect can be obtained will be described below.

In a case where light is incident from the normal direction of the optical laminate 10B (case where light is incident from the upper side toward the lower side on the paper plane of FIG. 8), the transmittance central axis of the first light absorption anisotropic layer 12B is tilted by 5° from the normal direction. Therefore, the transmittance central axis of the first light absorption anisotropic layer 12B can function as an absorption axis for the light incident into the optical laminate 10B. Note that, since the tilt of the transmittance central axis is small, the amount of light absorbed is small, and most of the light incident into the first light absorption anisotropic layer 12B transmits as it is.

Next, in a case where the light transmitted through the first light absorption anisotropic layer 12B is incident into the retardation layer 14B, the direction of linearly polarized light of the incident light is rotated by 90°. For example, a direction of linearly polarized light in a direction orthogonal to the transmittance central axis of the first light absorption anisotropic layer 12B is rotated by 90°.

Next, in a case where the light transmitted through the retardation layer 14B is incident into the second light absorption anisotropic layer 16B, the direction of the linearly polarized light rotated by the retardation layer 14B overlaps the direction of the transmittance central axis of the second light absorption anisotropic layer 16B. Therefore, the transmittance central axis of the second light absorption anisotropic layer 16B functions as an absorption axis, and a part of light incident into the second light absorption anisotropic layer 16B is absorbed. Note that, since the tilt of the transmittance central axis is small, the amount of light absorbed is small, and most of the light incident into the second light absorption anisotropic layer 16B transmits as it is.

That is, in a case where light is incident from the normal direction of the optical laminate 10B, a part of the incident light is absorbed by the first light absorption anisotropic layer 12B and the second light absorption anisotropic layer 16B, but most of the incident light transmits as it is.

On the other hand, in a case where light is incident from a white arrow of FIG. 8 into the optical laminate 10B, the transmittance central axis of the first light absorption anisotropic layer 12B can function as an absorption axis for the oblique incident light. In particular, as the tilt of the incident light from the normal direction increases, the transmittance central axis of the first light absorption anisotropic layer 12B can function as an absorption axis. Therefore, light transmitted through the first light absorption anisotropic layer 12B is light where the amount of linearly polarized light in a direction (front-depth direction on the paper plane of FIG. 8) orthogonal to the transmittance central axis of the first light absorption anisotropic layer 12B is large.

Next, in a case where the light transmitted through the first light absorption anisotropic layer 12B is incident into the retardation layer 14B, the direction of the linearly polarized light in the direction orthogonal to the transmittance central axis of the first light absorption anisotropic layer 12B is rotated by 90°.

Next, in a case where the light transmitted through the retardation layer 14B is incident into the second light absorption anisotropic layer 16B, the direction of the linearly polarized light rotated by the retardation layer 14B overlaps the direction of the transmittance central axis of the second light absorption anisotropic layer 16B. Therefore, the transmittance central axis of the second light absorption anisotropic layer 16B functions as an absorption axis, and light incident into the second light absorption anisotropic layer 16B is absorbed. In particular, as the tilt of the incident light from the normal direction increases, the transmittance central axis of the second light absorption anisotropic layer 16B can function as an absorption axis.

In addition, as in the case where light is incident from the white arrow, even in a case where light is incident from a black arrow of FIG. 8 into the optical laminate 10B, the transmittance central axis of the first light absorption anisotropic layer 12B and the transmittance central axis of the second light absorption anisotropic layer 16B can function as absorption axes.

In a case where incident light of the white arrow and incident light from the black arrow are compared to each other, an angle between the transmittance central axis of the first light absorption anisotropic layer 12B and the transmittance central axis of the second light absorption anisotropic layer 16B and the incident light is larger in the case of the incident light of the white arrow. Therefore, the incident light is likely to be absorbed.

As a result, the relationship of the first aspect shown in FIG. 6 is observed as a relationship between a polar angle and a luminance observed in a case where the optical laminate 10B is disposed on a light source. That is, a luminance during observation of the vicinity of the front direction is higher than a luminance during observation from a direction tilted to the left side and a luminance during observation from a direction tilted to the right side. In addition, in a case where the luminance during observation from the direction tilted to the left side and the luminance during observation from the direction tilted to the right side are compared to each other, the luminance during observation from the direction tilted to the right side is higher in terms of an absolute value at the same polar angle. That is, the intensity of the luminance during observation in the left-right direction is asymmetrical.

In FIG. 8, the aspect where the retardation layer is used has been described. However, a liquid crystal cell may also be used instead of a retardation layer.

In a case where the liquid crystal cell is used instead of the retardation layer, a switching function can be imparted to the optical laminate.

In addition, the angles of the transmittance central axes of the first light absorption anisotropic layer and the second light absorption anisotropic layer are not limited to the aspect of FIG. 8, and may be positioned in predetermined ranges described below.

Hereinafter, each of the members in the optical laminate according to the second aspect will be described in detail.

### <First Light Absorption Anisotropic Layer>

The first light absorption anisotropic layer has the transmittance central axis.

In the first light absorption anisotropic layer, an angle A1 between the transmittance central axis of the first light absorption anisotropic layer and the normal direction of the first light absorption anisotropic layer is more than 0° and 45° or less. In particular, from the viewpoint that the luminance in a direction tilted from the front direction is more asymmetrical in a case where the optical laminate is disposed on a light source, the angle A3 is preferably 5° to 35°, more preferably 5° to 25°, and still more preferably 5° to 15°.

The thickness of the first light absorption anisotropic layer is not particularly limited, and is preferably 0.5 to 7 μm and more preferably 0.5 to 5 μm.

A material for forming the first light absorption anisotropic layer is not particularly limited, and examples thereof include the above-described material for forming the first light absorption anisotropic layer in the optical laminate according to the first aspect.

Examples of a method of manufacturing the first light absorption anisotropic layer include the above-described method of manufacturing the first light absorption anisotropic layer in the optical laminate according to the first aspect.

### <Second Light Absorption Anisotropic Layer>

The second light absorption anisotropic layer has the transmittance central axis.

In the second light absorption anisotropic layer, an angle A2 between the transmittance central axis of the second light absorption anisotropic layer and the normal direction of the second light absorption anisotropic layer is more than 0° and 45° or less. In particular, from the viewpoint that the luminance in a direction tilted from the front direction is more asymmetrical in a case where the optical laminate is disposed on a light source, the angle A2 is preferably 5° to 35°, more preferably 10° to 30°, still more preferably 15° to 25°, and still more preferably more than 15° and 25° or less.

The thickness of the second light absorption anisotropic layer is not particularly limited, and is preferably 0.5 to 7 μm and more preferably 0.5 to 5 μm.

A material for forming the second light absorption anisotropic layer is not particularly limited, and examples thereof include the above-described material for forming the first light absorption anisotropic layer in the optical laminate according to the first aspect.

Examples of a method of manufacturing the second light absorption anisotropic layer include the above-described method of manufacturing the first light absorption anisotropic layer in the optical laminate according to the first aspect.

### <Relationship Between First Light Absorption Anisotropic Layer and Second Light Absorption Anisotropic Layer>

In the optical laminate according to the second aspect, an angle A1 between the transmittance central axis of the first light absorption anisotropic layer and the normal direction of the first light absorption anisotropic layer and an angle A2 between the transmittance central axis of the second light absorption anisotropic layer and the normal direction of the second light absorption anisotropic layer are different. That is, the angle A1 and the angle A2 have different angles.

An absolute value of a difference between the angle A1 and the angle A2 is not particularly limited, and is preferably 5° or more and more preferably 10° or more from the viewpoint that the luminance in a direction tilted from the front direction is more asymmetrical in a case where the optical laminate is disposed on a light source. The upper limit is not particularly limited and is preferably 30° or less and more preferably 20° or less.

In addition, an angle between an orientation in an in-plane direction of the transmittance central axis of the first light absorption anisotropic layer and an orientation in an in-plane direction of the transmittance central axis of the second light absorption anisotropic layer is 180°±20°. That is, the above-described angle is in a range of 160° to 200°. In particular, from the viewpoint that the luminance in a direction tilted from the front direction is more asymmetrical in a case where the optical laminate is disposed on a light source, the above-described angle is preferably 180°±10° and more preferably 180°±5°.

For example, in a case where the second light absorption anisotropic layer is observed from the first light absorption anisotropic layer side, the orientation in the in-plane direction of the transmittance central axis of the first light absorption anisotropic layer refers to an orientation in the in-plane direction of the first light absorption anisotropic layer in which the transmittance central axis extends (is present) with respect to the surface of the first light absorption anisotropic layer on the second light absorption anisotropic layer side. For example, in the first light absorption anisotropic layer 12B in the optical laminate 10B shown in FIG. 8, as in the case of the third light absorption anisotropic layer in the optical laminate according to the first aspect shown in FIG. 4, the transmittance central axis extends in the negative direction of the x-axis with respect to the surface of the first light absorption anisotropic layer on the second light absorption anisotropic layer side. Accordingly, the orientation in the in-plane direction of the transmittance central axis in this case corresponds to the negative direction of the x-axis.

In addition, for example, in a case where the second light absorption anisotropic layer is observed from the first light absorption anisotropic layer side, the orientation in the in-plane direction of the transmittance central axis of the second light absorption anisotropic layer refers to an orientation in the in-plane direction of the second light absorption anisotropic layer in which the transmittance central axis extends (is present) with respect to the surface of the second light absorption anisotropic layer opposite to the first light absorption anisotropic layer side. For example, in the second light absorption anisotropic layer 16B in the optical laminate 10B shown in FIG. 8, as in the case of the first light absorption anisotropic layer in the optical laminate according to the first aspect shown in FIG. 3, the transmittance central axis extends in the positive direction of the x-axis with respect to the surface of the second light absorption anisotropic layer opposite to the first light absorption anisotropic layer side. Accordingly, the orientation in the in-plane direction of the transmittance central axis in this case corresponds to the positive direction of the x-axis.

### <Retardation Layer>

The retardation layer has a function of changing a direction of linearly polarized light incident from the normal direction of the retardation layer to a direction having an angle of 90°±10° with respect to the direction and emitting the incident light. In other words, an angle between a direction of linearly polarized light of light incident into the retardation layer and a direction of linearly polarized light of light transmitted through the retardation layer is 90°±10°.

The configuration of the retardation layer is not particularly limited as long as it has the above-described function, and examples thereof include a retardation layer obtained by immobilizing a liquid crystal compound that is twisted and aligned along a helical axis extending along a thickness direction, a λ/2 plate, and a laminate where two λ/2 plates are laminated such that an angle between in-plane slow axes of the two λ/2 plates is in a range of 45°±10°.

The configuration of each of the layers is as described above regarding the first retardation layer in the optical laminate according to the first aspect.

### <Liquid Crystal Cell>

The liquid crystal cell is a liquid crystal cell in a TN mode, a liquid crystal cell in a VA mode, a liquid crystal cell in an OCB mode, or a liquid crystal cell in an ECB mode.

The configuration of the liquid crystal cell in each of the modes is as described above regarding the first liquid crystal cell in the optical laminate according to the first aspect.

### <Other Members>

The optical laminate may include members other than the above-described various members (the first light absorption anisotropic layer and the second light absorption anisotropic layer, the retardation layer, and the liquid crystal cell).

Examples of the other members include a bonding layer such as an adhesive layer and a pressure-sensitive adhesive layer.

As an adhesive used for the adhesive layer and a pressure sensitive adhesive used for the pressure-sensitive adhesive layer, a well-known material can be used.

Examples of the other members include an alignment film. The alignment film may be a photo-alignment film.

The alignment film that is used is not particularly limited, and examples thereof include a well-known alignment film.

Examples of the other members include a support.

The support is a member for supporting various materials. As the support, a well-known support may be used, and a resin support is preferable. Examples of the resin support include the resin support described regarding the first aspect.

The thickness of the support is not particularly limited and is preferably 10 to 100 μm.

Examples of the other members include an oxygen blocking layer.

### <Method of Manufacturing Optical Laminate>

A method of manufacturing the optical laminate is not particularly limited, and examples thereof include a method of preparing the above-described various members and laminating the members through a bonding layer or the like.

### Third Aspect

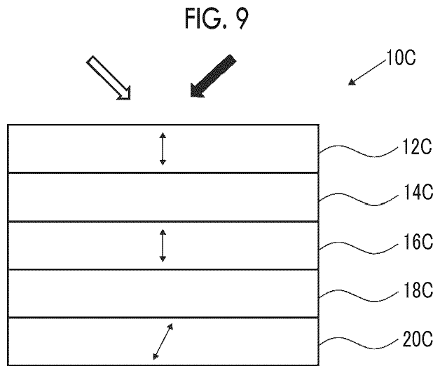

FIG. 9 shows an example of the optical laminate according to the third aspect of the present invention.

An optical laminate 10C shown in FIG. 9 includes a first light absorption anisotropic layer 12C, a first retardation layer 14C, a second light absorption anisotropic layer 16C, a second retardation layer 18C, and a third light absorption anisotropic layer 20C in this order.

An arrow in the first light absorption anisotropic layer 12C shown in FIG. 9 indicates a transmittance central axis, and an angle between the transmittance central axis of the first light absorption anisotropic layer 12C and a normal direction of the first light absorption anisotropic layer 12C (in other words, a normal direction of the optical laminate 10C) is 0°.

An arrow in the second light absorption anisotropic layer 16C shown in FIG. 9 indicates a transmittance central axis, and an angle between the transmittance central axis of the second light absorption anisotropic layer 16C and the normal direction of the second light absorption anisotropic layer 16C (in other words, the normal direction of the optical laminate 10C) is 0°.

An arrow in the third light absorption anisotropic layer 20C shown in FIG. 9 indicates a transmittance central axis, and the transmittance central axis of the third light absorption anisotropic layer 20C is tilted at a polar angle of 10° with respect to the normal direction of the third light absorption anisotropic layer 20C (in other words, the normal direction of the optical laminate 10C). The transmittance central axis of the third light absorption anisotropic layer 20C is tilted to the right side (clockwise) in FIG. 9 with respect to the normal direction.

In addition, an average value AX of a transmittance of the first light absorption anisotropic layer 12C in a direction along the transmittance central axis of the first light absorption anisotropic layer 12C and a transmittance of the second light absorption anisotropic layer 16C in a direction along the transmittance central axis of the second light absorption anisotropic layer 16C is more than an average value AY of the transmittance of the second light absorption anisotropic layer 16C in the direction along the transmittance central axis of the second light absorption anisotropic layer 16C and a transmittance of the third light absorption anisotropic layer 20C in a direction along the transmittance central axis of the third light absorption anisotropic layer 20C.

The first retardation layer 14C and the second retardation layer 18C shown in FIG. 9 are layers that rotate by 90° linearly polarized light incident from the normal direction of the retardation layer. The first retardation layer 14C and the second retardation layer 18C are so-called optical rotation layers.

By using the optical laminate 10C having the above-described configuration, a mechanism with which a desired effect can be obtained will be described below.

First, a mechanism obtained by the three layers including the first light absorption anisotropic layer 12C, the first retardation layer 14C, and the second light absorption anisotropic layer 16C in the optical laminate 10C will be described.

In a case where three layer portions including the first light absorption anisotropic layer 12C, the first retardation layer 14C, and the second light absorption anisotropic layer 16C are disposed on a light source and a luminance is observed while changing a polar angle, a relationship between a polar angle and a luminance shown in FIG. 6 of the first aspect is obtained.

As described above, the average value AX is more than the average value AY, and the transmittance of the first light absorption anisotropic layer 12C in the direction along the transmittance central axis of the first light absorption anisotropic layer 12C and the transmittance of the second light absorption anisotropic layer 16C in the direction along the transmittance central axis of the second light absorption anisotropic layer 16C are relatively high. Therefore, the amount of light absorbed by the first light absorption anisotropic layer 12C and the second light absorption anisotropic layer 16C is small, and a state where a luminance is high in a wide range in the vicinity of the front direction is achieved.

In addition, both of the transmittance central axis of the first light absorption anisotropic layer 12C and the transmittance central axis of the second light absorption anisotropic layer 16C are along the normal direction of each of the layers. Therefore, the intensity of the luminance to be observed in the left-right direction is symmetrical.

Next, a mechanism obtained by the three layers including the second light absorption anisotropic layer 16C, the second retardation layer 18C, and the third light absorption anisotropic layer 20C in the optical laminate 10C will be described.

In a case where the three layer portions including the second light absorption anisotropic layer 16C, the second retardation layer 18C, and the third light absorption anisotropic layer 20C are disposed on a light source and a luminance is observed while changing a polar angle, a relationship between a polar angle and a luminance shown in FIG. 5 of the first aspect is obtained.

That is, a luminance during observation of the vicinity of the front direction is higher than a luminance during observation from a direction tilted to the left side and a luminance during observation from a direction tilted to the right side. In addition, in a case where the luminance during observation from the direction tilted to the left side and the luminance during observation from the direction tilted to the right side are compared to each other, the luminance during observation from the direction tilted to the right side is higher in terms of an absolute value at the same polar angle. That is, the intensity of the luminance during observation in the left-right direction is asymmetrical.

The optical laminate 10C includes a combination of the function by the three layer portions including the first light absorption anisotropic layer 12C, the first retardation layer 14C, and the second light absorption anisotropic layer 16C and the function by the three layer portions including the second light absorption anisotropic layer 16C, the second retardation layer 18C, and the third light absorption anisotropic layer 20C. More specifically, as the relationship between a polar angle and a luminance observed in a case where the optical laminate 10C is disposed on a light source, a relationship between a polar angle and a luminance shown in FIG. 7 of the first aspect is obtained.

In FIG. 9, the aspect where the first retardation layer and the second retardation layer are used has been described. However, a first liquid crystal cell described below may also be used instead of the first retardation layer, and a second liquid crystal cell described below may also be used instead of the second retardation layer.

In a case where the first liquid crystal cell is used instead of the first retardation layer, a switching function can be imparted to the optical laminate.

Even in a case where the second liquid crystal cell is used instead of the second retardation layer, a switching function can be imparted to the optical laminate.

In addition, the angles of the transmittance central axes of the first light absorption anisotropic layer, the second light absorption anisotropic layer, and the third light absorption anisotropic layer are not limited to the aspect of FIG. 9, and may be positioned in predetermined ranges described below.

Hereinafter, each of the members in the optical laminate according to the third aspect will be described in detail.

### <First Light Absorption Anisotropic Layer>

The first light absorption anisotropic layer has the transmittance central axis.

In the first light absorption anisotropic layer, an angle A1 between the transmittance central axis of the first light absorption anisotropic layer and the normal direction of the first light absorption anisotropic layer is 0° to 10°. In particular, from the viewpoint that the luminance in a direction tilted from the front direction is more asymmetrical in a case where the optical laminate is disposed on a light source, the angle A1 is preferably 0° to 5° and more preferably 0° to 2°.

The thickness of the first light absorption anisotropic layer is not particularly limited, and is preferably 0.5 to 7 μm and more preferably 0.5 to 5 μm.

A material for forming the first light absorption anisotropic layer is not particularly limited, and examples thereof include the above-described material for forming the first light absorption anisotropic layer in the optical laminate according to the first aspect.

Examples of a method of manufacturing the first light absorption anisotropic layer include the above-described method of manufacturing the first light absorption anisotropic layer in the optical laminate according to the first aspect.

### <Second Light Absorption Anisotropic Layer>

The second light absorption anisotropic layer has the transmittance central axis.

In the second light absorption anisotropic layer, an angle A2 between the transmittance central axis of the second light absorption anisotropic layer and the normal direction of the second light absorption anisotropic layer is 0° to 10°. In particular, from the viewpoint that the luminance in a direction tilted from the front direction is more asymmetrical in a case where the optical laminate is disposed on a light source, the angle A1 is preferably 0° to 5° and more preferably 0° to 2°.

The thickness of the second light absorption anisotropic layer is not particularly limited, and is preferably 0.5 to 7 μm and more preferably 0.5 to 5 μm.

A material for forming the second light absorption anisotropic layer is not particularly limited, and examples thereof include the above-described material for forming the first light absorption anisotropic layer in the optical laminate according to the first aspect.

Examples of a method of manufacturing the second light absorption anisotropic layer include the above-described method of manufacturing the first light absorption anisotropic layer in the optical laminate according to the first aspect.

### <Third Light Absorption Anisotropic Layer>

The third light absorption anisotropic layer has the transmittance central axis.

In the third light absorption anisotropic layer, an angle A3 between the transmittance central axis of the third light absorption anisotropic layer and the normal direction of the third light absorption anisotropic layer is more than 0° and 45° or less. In particular, from the viewpoint that the luminance in a direction tilted from the front direction is more asymmetrical in a case where the optical laminate is disposed on a light source, the angle A3 is preferably 10° to 30° and more preferably 15° to 25°.

The thickness of the third light absorption anisotropic layer is not particularly limited, and is preferably 0.5 to 7 μm and more preferably 0.5 to 5 μm.

A material for forming the third light absorption anisotropic layer is not particularly limited, and examples thereof include the above-described material for forming the first light absorption anisotropic layer in the optical laminate according to the first aspect.

Examples of a method of manufacturing the third light absorption anisotropic layer include the above-described method of manufacturing the first light absorption anisotropic layer in the optical laminate according to the first aspect.

### <Relationship Between First Light Absorption Anisotropic Layer, Second Light Absorption Anisotropic Layer, and Third Light Absorption Anisotropic Layer>

An average value AX of a transmittance of the first light absorption anisotropic layer 12C in a direction along the transmittance central axis of the first light absorption anisotropic layer 12C and a transmittance of the second light absorption anisotropic layer 16C in a direction along the transmittance central axis of the second light absorption anisotropic layer 16C is more than an average value AY of the transmittance of the second light absorption anisotropic layer 16C in the direction along the transmittance central axis of the second light absorption anisotropic layer 16C and a transmittance of the third light absorption anisotropic layer 20C in a direction along the transmittance central axis of the third light absorption anisotropic layer 20C.

As a method of measuring the transmittance, the Mueller matrix at a wavelength of 550 nm is measured using AxoScan OPMF-2 (manufactured by Axometrics, Inc.). Specifically, first, the transmittance central axis is measured. In the method of measuring the transmittance central axis, as described above, an azimuthal angle at which the transmittance central axis is tilted is first searched for, the Mueller matrix at a wavelength of 550 nm is measured while changing the polar angle which is the angle with respect to the normal direction of the surface of the light absorption anisotropic layer from-70° to 70° at intervals of 1° in the surface (the plane that has the transmittance central axis and is orthogonal to the layer surface) having the normal direction of the light absorption anisotropic layer along the azimuthal angle, and the transmittance of the light absorption anisotropic layer at each of the angles is derived. As a result, the direction in which the transmittance is the highest is defined as the transmittance central axis, and this highest value is the transmittance of the light absorption anisotropic layer in the direction along the transmittance central axis of the light absorption anisotropic layer.

Examples of a method adjusting the transmittance of each of the light absorption anisotropic layers include a method of changing the thickness of the light absorption anisotropic layer and a method of changing the concentration of a dichroic substance in a case where the light absorption anisotropic layer includes the dichroic substance.

The angle A3 is more than any of the angle A1 or the angle A2.

An absolute value of a difference between the angle A3 and the angle A1 is not particularly limited, and is preferably 5° to 20° and more preferably 5° to 10° from the viewpoint that the luminance in a direction tilted from the front direction is more asymmetrical in a case where the optical laminate is disposed on a light source.

An absolute value of a difference between the angle A3 and the angle A2 is not particularly limited, and is preferably 5° to 20° and more preferably 5° to 10° from the viewpoint that the luminance in a direction tilted from the front direction is more asymmetrical in a case where the optical laminate is disposed on a light source.

### <First Retardation Layer>

The first retardation layer has a function of changing a direction of linearly polarized light incident from the normal direction of the first retardation layer to a direction having an angle of 90°±10° with respect to the direction and emitting the incident light. In other words, an angle between a direction of linearly polarized light of light incident into the first retardation layer and a direction of linearly polarized light of light transmitted through the first retardation layer is 90°±10°.

The configuration of the first retardation layer is not particularly limited as long as it has the above-described function, and examples thereof include a retardation layer obtained by immobilizing a liquid crystal compound that is twisted and aligned along a helical axis extending along a thickness direction, a λ/2 plate, and a laminate where two λ/2 plates are laminated such that an angle between in-plane slow axes of the two λ/2 plates is in a range of 45°±10°.

The configuration of each of the layers is as described above regarding the first retardation layer in the optical laminate according to the first aspect.

### <Second Retardation Layer>

The second retardation layer has a function of changing a direction of linearly polarized light incident from the normal direction of the second retardation layer to a direction having an angle of 90°±10° with respect to the direction and emitting the incident light. In other words, an angle between a direction of linearly polarized light of light incident into the second retardation layer and a direction of linearly polarized light of light transmitted through the second retardation layer is 90°±10°.

The configuration of the second retardation layer is not particularly limited as long as it has the above-described function, and examples thereof include a retardation layer obtained by immobilizing a liquid crystal compound that is twisted and aligned along a helical axis extending along a thickness direction, a λ/2 plate, and a laminate where two λ/2 plates are laminated such that an angle between in-plane slow axes of the two λ/2 plates is in a range of 45°±10°.

The configuration of each of the layers is as described above regarding the first retardation layer in the optical laminate according to the first aspect.

### <First Liquid Crystal Cell>

The first liquid crystal cell is a liquid crystal cell in a TN mode, a liquid crystal cell in a VA mode, a liquid crystal cell in an OCB mode, or a liquid crystal cell in an ECB mode.

The configuration of the liquid crystal cell in each of the modes is as described above regarding the first liquid crystal cell in the optical laminate according to the first aspect.

### <Second Liquid Crystal Cell>

The second liquid crystal cell is a liquid crystal cell in a TN mode, a liquid crystal cell in a VA mode, a liquid crystal cell in an OCB mode, or a liquid crystal cell in an ECB mode.

The configuration of the liquid crystal cell in each of the modes is as described above regarding the first liquid crystal cell in the optical laminate according to the first aspect.

### <Other Members>

The optical laminate may include members other than the above-described various members (the first light absorption anisotropic layer to the third light absorption anisotropic layer, the first retardation layer and second retardation layer, and the first liquid crystal cell and the second liquid crystal cell).

Examples of the other members include a bonding layer such as an adhesive layer and a pressure-sensitive adhesive layer.

As an adhesive used for the adhesive layer and a pressure sensitive adhesive used for the pressure-sensitive adhesive layer, a well-known material can be used.

Examples of the other members include an alignment film. The alignment film may be a photo-alignment film.

The alignment film that is used is not particularly limited, and examples thereof include a well-known alignment film.

Examples of the other members include a support.

The support is a member for supporting various materials. As the support, a well-known support may be used, and a resin support is preferable. Examples of the resin support include the resin support described regarding the first aspect.

The thickness of the support is not particularly limited and is preferably 10 to 100 μm.

Examples of the other members include an oxygen blocking layer.

### <Method of Manufacturing Optical Laminate>

A method of manufacturing the optical laminate is not particularly limited, and examples thereof include a method of preparing the above-described various members and laminating the members through a bonding layer or the like.

### [Use]

The optical laminate according to the embodiment of the present invention is applicable to various uses.

For example, the optical laminate according to the embodiment of the present invention can is applicable to an image display apparatus. More specifically, the image display apparatus according to the embodiment of the present invention comprises an image display element and the above-described optical laminate (the first to third aspects).

Examples of the image display element include a liquid crystal display device, an organic electroluminescence display element, and a micro light emitting diode (LED) display.

In a case where the optical laminate is disposed on the image display element, a lamination direction thereof is not particularly limited.

For example, in a case where the optical laminate according to the first aspect is disposed on the image display element, the optical laminate may be laminated on the image display element such that the third light absorption anisotropic layer side faces the image display element, or the optical laminate may be laminated on the image display element such that the first light absorption anisotropic layer side faces the image display element. That is, the image display apparatus may include the image display element, the third light absorption anisotropic layer, the second retardation layer or the second liquid crystal cell, the second light absorption anisotropic layer, the first retardation layer or the first liquid crystal cell, and the first light absorption anisotropic layer in this order, or the image display apparatus may include the image display element, the first light absorption anisotropic layer, the first retardation layer or the first liquid crystal cell, the second light absorption anisotropic layer, the second retardation layer or the second liquid crystal cell, and the third light absorption anisotropic layer in this order.

In addition, in a case where the optical laminate according to the second aspect is disposed on the image display element, the optical laminate may be laminated on the image display element such that the second light absorption anisotropic layer side faces the image display element, or the optical laminate may be laminated on the image display element such that the first light absorption anisotropic layer side faces the image display element. That is, the image display apparatus may include the image display element, the second light absorption anisotropic layer, the retardation layer or the liquid crystal cell, and the first light absorption anisotropic layer in this order, or the image display apparatus may include the image display element, the first light absorption anisotropic layer, the retardation layer or the liquid crystal cell, and the second light absorption anisotropic layer in this order.

In addition, in a case where the optical laminate according to the third aspect is disposed on the image display element, the optical laminate may be laminated on the image display element such that the third light absorption anisotropic layer side faces the image display element, or the optical laminate may be laminated on the image display element such that the first light absorption anisotropic layer side faces the image display element. That is, the image display apparatus may include the image display element, the third light absorption anisotropic layer, the second retardation layer or the second liquid crystal cell, the second light absorption anisotropic layer, the first retardation layer or the first liquid crystal cell, and the first light absorption anisotropic layer in this order, or the image display apparatus may include the image display element, the first light absorption anisotropic layer, the first retardation layer or the first liquid crystal cell, the second light absorption anisotropic layer, the second retardation layer or the second liquid crystal cell, and the third light absorption anisotropic layer in this order.

The image display apparatus according to the embodiment of the present invention may be in an aspect in which viewing angles of a plurality of regions in a display screen are independently switchable.

### EXAMPLES

The present invention will be described in more detail based on the following examples. Materials, used amounts, ratios, treatment details, treatment procedures, and the like shown in the following examples can be appropriately changed within a range not departing from the scope of the present invention. Accordingly, the scope of the present invention is not limited to the following examples.

### Example 1

### [Formation of Light Absorption Anisotropic Layer A1]

### <Formation of Alignment Film 1>

A surface of a cellulose acylate film (TAC substrate; manufactured by FUJIFILM Corporation, TG40) with a thickness of 40 μm was saponified with an alkaline solution, and the following composition 1 for forming an alignment film was applied thereto using a wire bar.

The support on which the coating film was formed was dried with hot air at 60° C. for 60 seconds and further dried with hot air at 100° C. for 120 seconds to form an alignment film 1, thereby obtaining a TAC film with an alignment film.

The film thickness of the alignment film 1 was 1 μm.

Composition 1 for Forming Alignment Film

| | | |
|---|---|---|
| Modified polyvinyl alcohol PVA-1 shown below | 3.80 | parts by mass |
| IRGACURE 2959 | 0.20 | parts by mass |
| Water | 70 | parts by mass |
| Methanol | 30 | parts by mass |

Modified Polyvinyl Alcohol PVA-1

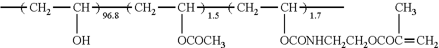

### <Formation of Light Absorption Anisotropic Layer A1>

The following composition 1 for forming a light absorption anisotropic layer was continuously applied to the obtained alignment film 1 using a wire bar, heated at 120° C. for 60 seconds, and then cooled to room temperature (23° C.). Next, the coating film was heated at 80° C. for 60 seconds and cooled to room temperature.

Next, the coating film was irradiated with ultraviolet light using a light emitting diode (LED) lamp (central wavelength: 365 nm) under an irradiation condition of an illuminance of 200 mW/cm² for 2 seconds to form a light absorption anisotropic layer A1 on the alignment film 1. The film thickness of the light absorption anisotropic layer A1 was 3.5 μm.

Composition of Composition 1 for Forming Light Absorption Anisotropic Layer

| | | |
|---|---|---|
| Dichroic substance D-1 shown below | 0.63 | parts by mass |
| Dichroic substance D-2 shown below | 0.17 | parts by mass |
| Dichroic substance D-3 shown below | 1.13 | parts by mass |
| Polymer liquid crystal compound P-1 shown below | 7.12 | parts by mass |
| Low-molecular-weight liquid crystal compound M-1 shown below | 1.00 | parts by mass |
| IRGACURE OXE-02 (manufactured by BASF SE) | 0.16 | parts by mass |
| Compound E-1 shown below | 0.12 | parts by mass |
| Compound E-2 shown below | 0.12 | parts by mass |
| Surfactant F-1 shown below | 0.05 | parts by mass |
| Cyclopentanone | 85.00 | parts by mass |
| Benzyl alcohol | 4.50 | parts by mass |

Dichroic Substance D-1 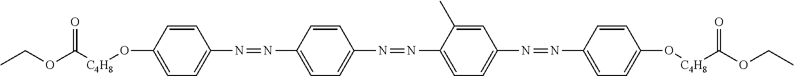
Dichroic Substance D-2 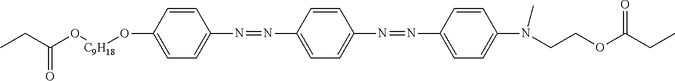
Dichroic Substance D-3 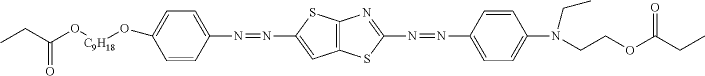
Polymer Liquid Crystal Compound P-1 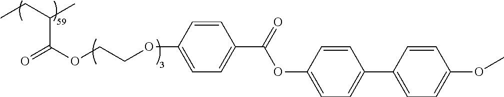 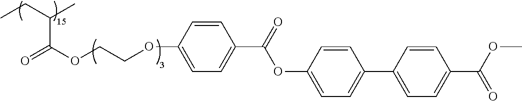 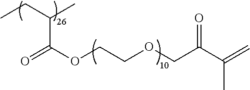
Low-Molecular-Weight Liquid Crystal Compound M-1 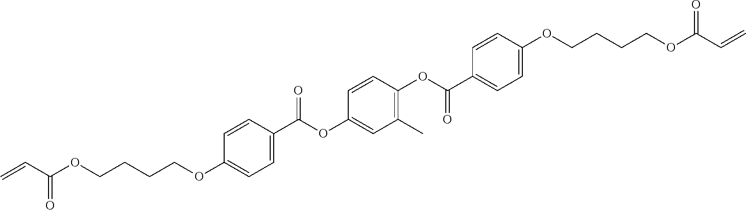 [SMILES: C=CC(=O)OCCCCOc1ccc(C(=O)Oc2ccc(OC(=O)c3ccc(OCCCCOC(=O)C=C)cc3)c(C)c2)cc1]
Compound E-1 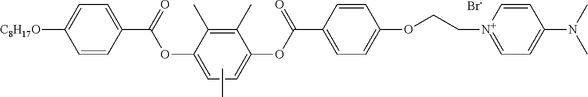
Compound E-2 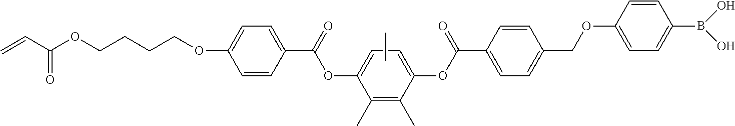
Surfactant F-1

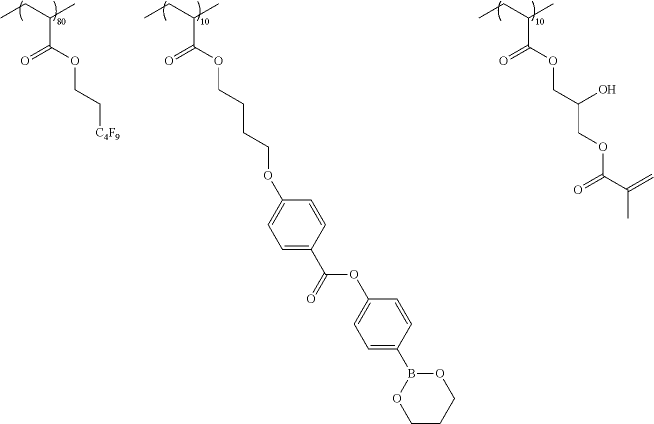

Regarding the prepared light absorption anisotropic layer A1, an angle between the transmittance central axis of the light absorption anisotropic layer and the normal direction of the light absorption anisotropic layer was measured using the following method. The results are shown in Table 1 below.

### <Measurement of Alignment Angle of Light Absorption Anisotropic Layer>

The light absorption anisotropic layer A1 was horizontally provided on a sample stage, and a transmittance was measured using AxoScan OPMF-2 (manufactured by Axometrics, Inc.) as described above while variously changing an azimuthal angle and a polar angle at which P polarized light was incident into this film. As a result, the azimuthal angle and the polar angle of the transmittance central axis of the light absorption anisotropic layer A1 were investigated.

### Formation of Oxygen Blocking Layer B1>

A coating liquid having the following composition (composition B1 for forming an oxygen blocking layer) was continuously applied to the formed light absorption anisotropic layer A1 using a wire bar. Next, the coating film was dried with hot air at 100° C. for 2 minutes to obtain a coating layer B1.

Next, in an environment where the oxygen concentration was 100 ppm and the temperature was 60° C., the coating layer B1 was irradiated with ultraviolet light using a LED lamp (central wavelength: 365 nm) under an irradiation condition of an illuminance of 150 mW/cm² for 2 seconds to form an oxygen blocking layer B1 on the light absorption anisotropic layer A1.

The thickness of the oxygen blocking layer B1 was 1.0 μm.

This way, an optical film A1 including a cellulose acylate film, the alignment film 1, the light absorption anisotropic layer A1, and the oxygen blocking layer B1 in this order to be adjacent to each other was obtained.

Composition of Composition B1 for
Forming Oxygen Blocking Layer

| | |
|---|---|
| Modified polyvinyl alcohol PVA-1 shown above | 3.80 parts by mass |
| Polymerization initiator | |
| (IRGACURE 2959, manufactured by BASF SE) | 0.20 parts by mass |
| Water | 70 parts by mass |
| Methanol | 30 parts by mass |

### [Formation of Light Absorption Anisotropic Layer A2]

### <Preparation of Liquid Crystal Layer 1 for Alignment>

A liquid crystal layer-forming composition Tl for alignment having the following composition was applied using a wire bar to the alignment film of the TAC film with the alignment film 1 prepared in Example 1 to prepare a coating layer T1.

Next, the coating layer T1 was heated at 120° C. for 30 seconds and cooled to room temperature (23° C.). Further, the coating layer was heated at 80° C. for 60 seconds and cooled to room temperature.

Next, the coating layer was irradiated with light using a LED lamp (central wavelength: 365 nm) under an irradiation conditions of an illuminance of 200 mW/cm² for 1 second to prepare a liquid crystal layer T1 for alignment on the alignment layer 1.

The film thickness of the liquid crystal layer T1 for alignment was 0.6 μm.

Composition of liquid crystal layer-forming composition T1 for alignment

| | | |
|---|---|---|
| Polymer liquid crystal compound P-2 shown below | 55.20 | parts by mass |
| Low-molecular-weight liquid crystal compound M-1 shown above | 40.49 | parts by mass |
| Polymerization initiator | | |
| (IRGACURE OXE-02, manufactured by BASF SE) | 4.049 | parts by mass |
| Surfactant F-2 shown below | 0.109 | parts by mass |
| Cyclopentanone | 660.6 | parts by mass |
| Tetrahydrofuran | 660.6 | parts by mass |

Polymer Liquid Crystal Compound P-2 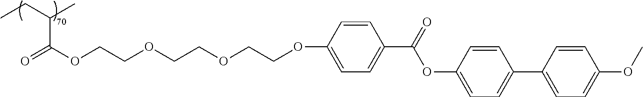 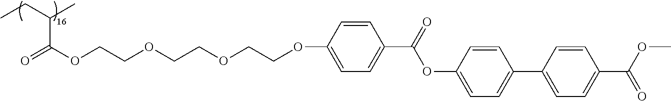 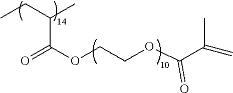
Surfactant F-2

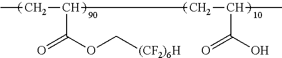

### <Formation of Light Absorption Anisotropic Layer A2>

The following composition P2 for forming a light absorption anisotropic layer was applied to the obtained liquid crystal layer T1 for alignment using a wire bar to form a coating layer A2.

Next, the coating layer A2 was heated at 120° C. for 30 seconds and cooled to room temperature (23° C.).

Next, the coating layer was heated at 80° C. for 60 seconds and cooled to room temperature.

Next, the coating layer was irradiated with light using a LED lamp (central wavelength: 365 nm) under an irradiation conditions of an illuminance of 200 mW/cm² for 1 second to prepare a light absorption anisotropic layer A2 on the liquid crystal layer 1 for alignment.

The film thickness of the light absorption anisotropic layer A2 was 2.5 μm.

Composition of composition P2 for forming light absorption anisotropic layer

| | | |
|---|---|---|
| Dichroic substance D-1 shown above | 7.356 | parts by mass |
| Dichroic substance D-2 shown above | 3.308 | parts by mass |
| Dichroic substance D-3 shown above | 11.02 | parts by mass |
| Polymer liquid crystal compound P-1 | 43.29 | parts by mass |
| Low-molecular-weight liquid crystal compound M-1 | 31.75 | parts by mass |
| Polymerization initiator | | |
| (IRGACURE OXE-02, manufactured by BASF SE) | 3.175 | parts by mass |
| Surfactant F-3 shown below | 0.0575 | parts by mass |
| Cyclopentanone | 514.4 | parts by mass |
| Tetrahydrofuran | 514.4 | parts by mass |

Surfactant F-3

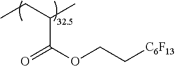

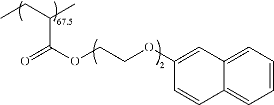

### <Formation of Oxygen Blocking Layer B1>

Using the same method as that of Example 1, the oxygen blocking layer B1 was formed on the prepared light absorption anisotropic layer A2 to obtain an optical film A2.

Regarding the prepared light absorption anisotropic layer A2, an angle between the transmittance central axis of the light absorption anisotropic layer and the normal direction of the light absorption anisotropic layer was measured using the above-described method. The results are shown in Table 1 below.

### [Preparation of Optical Rotation Layer]

### Preparation of Transfer Film

A surface of a PET film (manufactured by FUJIFILM Corporation) having a thickness of 75 μm was rubbed to prepare a peelable support.

The following coating liquid for an optical rotation layer was applied to the rubbed surface of the prepared peelable support using a bar coater to form a coating film such that the film thickness of the obtained coating film was 2.8 μm

Next, the coating film was heated and aged under a condition of a coating film surface temperature of 60° C. for 90 seconds and was irradiated with ultraviolet light at 100° C. and 300 mJ/cm². As a result, the alignment of the liquid crystal compound was immobilized to form an optical rotation layer, and a transfer film including the peelable support and the optical rotation layer was prepared.

In the obtained optical rotation layer, Δn of the liquid crystal compound was 0.16, and Δnd was 450 nm. In addition, the optical rotation layer included a liquid crystal compound that was twisted and aligned along a helical axis extending along a thickness direction. In a case where a twisted angle of a helical liquid crystal compound was checked by analysis using AxoScan OPMF-2 (manufactured by Axometrics, Inc.), the twisted angle was 90°.

The transfer film including the optical rotation layer was interposed between two polarizing plates, and the two polarizing plates were rotated in an in-plane direction such that light transmitted through the two polarizing plates was the darkest. By measuring an angle between transmission axes of the two polarizing plates at this time, a rotation angle of the polarization direction of the linearly polarized light by the optical rotation layer was measured. As a result, the optical rotation layer was an optical rotation layer where the polarization direction of the linearly polarized light was rotated by 90°.

Coating Liquid for Optical Rotation Layer

| | | |
|---|---|---|
| Methyl ethyl ketone | 233 | parts by mass |
| Cyclohexanone | 12 | parts by mass |
| Rod-like liquid crystal compound 201 shown below | 83 | parts by mass |
| Rod-like liquid crystal compound 202 shown below | 15 | parts by mass |
| Rod-like liquid crystal compound 203 shown below | 2 | parts by mass |
| Polyfunctional monomer A-TMMT (manufactured by Shin-Nakamura Chemical Co., Ltd.) | 1 | parts by mass |
| IRGACURE 819 (manufactured by BASF SE) | 4 | parts by mass |
| Surfactant 1 shown below | 0.05 | parts by mass |
| Surfactant 2 shown below | 0.01 | parts by mass |
| Chiral agent shown below | 0.123 | parts by mass |

Rod-Like Liquid Crystal Compound 201 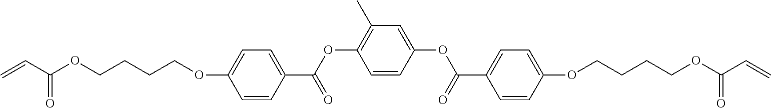 [SMILES: C=CC(=O)OCCCCOc1ccc(C(=O)Oc2ccc(OC(=O)c3ccc(OCCCCOC(=O)C=C)cc3)c(C)c2)cc1]
Rod-Like Liquid Crystal Compound 202 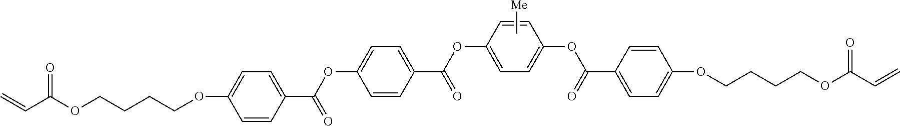
Rod-Like Liquid Crystal Compound 203 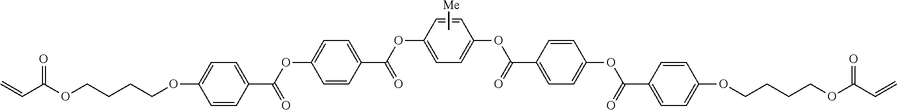
Surfactant 1 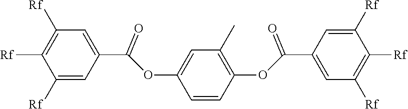 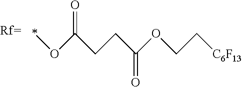
Surfactant 2 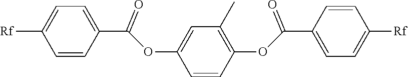 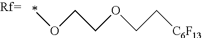
Chiral Agent

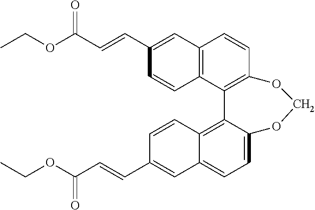

### <Preparation of Optical Laminate A1>

The coating layer side of the optical film A2 and the optical rotation layer side of the transfer film were bonded to face each other using a commercially available pressure sensitive adhesive (SK2057, manufactured by Soken Chemical & Engineering Co., Ltd.). Next, the peelable support of the transfer film was peeled off. Further, the optical rotation layer surface and the coating layer of the newly prepared optical film A2 were bonded to face each other using a commercially available pressure sensitive adhesive (SK2057, manufactured by Soken Chemical & Engineering Co., Ltd.). In this case, the two light absorption anisotropic layers A2 were bonded such that an angle between orientations in the in-plane direction of the transmittance central axes thereof was 180°. That is, as in the relationship between the second light absorption anisotropic layer 16A and the third light absorption anisotropic layer 20A shown in FIG. 1, the two light absorption anisotropic layers A2 were bonded such that the transmittance central axes thereof were tilted with respect to the normal direction thereof. Further, the support surface of the optical film A2 and the optical rotation layer side of the transfer film were bonded to face each other using a commercially available pressure sensitive adhesive (SK2057, manufactured by Soken Chemical & Engineering Co., Ltd.). Next, the peelable support of the transfer film was peeled off. Next, the optical rotation layer side and the coating layer side of the optical film A1 were bonded to face each other, and an optical laminate A1 was prepared.

### Example 2

### [Formation of Light Absorption Anisotropic Layer A3]

### <Preparation of Liquid Crystal Layer 2 for Alignment>

A liquid crystal layer 2 for alignment was prepared using the same method as that of the preparation of the liquid crystal layer 1 for alignment, except that the liquid crystal layer-forming composition T1 for alignment was changed to the following liquid crystal layer-forming composition T2 for alignment, and the film thickness of the liquid crystal layer 2 for alignment was changed to 0.7 μm.

Composition of liquid crystal layer-
forming composition T2 for alignment

| | |
|---|---|
| Polymer liquid crystal compound P-2 | 55.20 parts by mass |
| shown above | |
| Low-molecular-weight liquid crystal | 40.49 parts by mass |
| compound M-1 shown above | |
| Polymerization initiator | |
| (IRGACURE OXE-02, manufactured by | 4.049 parts by mass |
| BASF SE) | |
| Surfactant F-2 shown above | 0.094 parts by mass |
| Cyclopentanone | 660.6 parts by mass |
| Tetrahydrofuran | 660.6 parts by mass |

### <Formation of Light Absorption Anisotropic Layer A3>

A light absorption anisotropic layer A3 was formed using the same method as that of the preparation of the light absorption anisotropic layer A2, except that the liquid crystal layer 1 for alignment was changed to the liquid crystal layer 2 for alignment, the composition P2 for forming a light absorption anisotropic layer was changed to the following composition P3 for forming a light absorption anisotropic layer, and the film thickness of the light absorption anisotropic layer was changed to 3.5 μm. Using this light absorption anisotropic layer A3, an optical film A3 was prepared.

Composition of composition P3 for forming
light absorption anisotropic layer

| | |
|---|---|
| Dichroic substance D-1 shown above | 7.356 parts by mass |
| Dichroic substance D-2 shown above | 3.308 parts by mass |
| Dichroic substance D-3 shown above | 11.02 parts by mass |
| Polymer liquid crystal compound P-1 | 43.29 parts by mass |
| Low-molecular-weight liquid crystal | 31.75 parts by mass |
| compound M-1 | |
| Polymerization initiator | |
| (IRGACURE OXE-02, manufactured by | 3.175 parts by mass |
| BASF SE) | |
| Surfactant F-3 shown above | 0.0411 parts by mass |
| Cyclopentanone | 514.4 parts by mass |
| Tetrahydrofuran | 514.4 parts by mass |

### [Formation of Light Absorption Anisotropic Layer A4]

### <Preparation of Liquid Crystal Layer 3 for Alignment>

A liquid crystal layer 3 for alignment was prepared using the same method as that of the preparation of the liquid crystal layer 1 for alignment, except that the liquid crystal layer-forming composition T1 for alignment was changed to the following liquid crystal layer-forming composition T3 for alignment, and the film thickness of the liquid crystal layer 3 for alignment was changed to 0.46 μm.

Composition of liquid crystal layer-
forming composition T3 for alignment

| | |
|---|---|
| Polymer liquid crystal compound P-2 | 55.20 parts by mass |
| shown above | |
| Low-molecular-weight liquid crystal | 40.49 parts by mass |
| compound M-1 shown above | |
| Polymerization initiator | |
| (IRGACURE OXE-02, manufactured by | 4.049 parts by mass |
| BASF SE) | |
| Surfactant F-2 shown above | 0.142 parts by mass |
| Cyclopentanone | 660.6 parts by mass |
| Tetrahydrofuran | 660.6 parts by mass |

### <Formation of Light Absorption Anisotropic Layer A4>

A light absorption anisotropic layer A4 was formed using the same method as that of the preparation of the light absorption anisotropic layer A2, except that the liquid crystal layer 1 for alignment was changed to the liquid crystal layer 3 for alignment, the composition P2 for forming a light absorption anisotropic layer was changed to the following composition P4 for forming a light absorption anisotropic layer, and the film thickness of the light absorption anisotropic layer was changed to 1.0 μm. Using this light absorption anisotropic layer A4, an optical film A4 was prepared.

Composition of composition P4 for forming
light absorption anisotropic layer

| | |
|---|---|
| Dichroic substance D-1 shown above | 7.356 parts by mass |
| Dichroic substance D-2 shown above | 3.308 parts by mass |
| Dichroic substance D-3 shown above | 11.02 parts by mass |
| Polymer liquid crystal compound P-1 | 43.29 parts by mass |
| Low-molecular-weight liquid crystal | 31.75 parts by mass |
| compound M-1 | |
| Polymerization initiator | |
| (IRGACURE OXE-02, manufactured by | 3.175 parts by mass |
| BASF SE) | |
| Surfactant F-3 shown above | 0.1438 parts by mass |
| Cyclopentanone | 514.4 parts by mass |
| Tetrahydrofuran | 514.4 parts by mass |

### <Preparation of Optical Laminate A2>

The coating layer side of the optical film A4 and the optical rotation layer side of the transfer film were bonded to face each other using a commercially available pressure sensitive adhesive (SK2057, manufactured by Soken Chemical & Engineering Co., Ltd.). Next, the peelable support of the transfer film was peeled off. Further, the optical rotation layer surface and the coating layer of the optical film A3 were bonded to face each other using a commercially available pressure sensitive adhesive (SK2057, manufactured by Soken Chemical & Engineering Co., Ltd.). In this case, the light absorption anisotropic layer A4 and the light absorption anisotropic layer A3 were bonded such that an angle between an orientation in an in-plane direction of the transmittance central axis of the light absorption anisotropic layer A4 and an orientation in an in-plane direction of the transmittance central axis of the light absorption anisotropic layer A3 was 180°. As a result, an optical laminate A2 was prepared. That is, as in the relationship between the first light absorption anisotropic layer 12B and the second light absorption anisotropic layer 16B shown in FIG. 8, the light absorption anisotropic layer A4 and the light absorption anisotropic layer A3 were bonded such that the transmittance central axis of the light absorption anisotropic layer A4 and the transmittance central axis of the light absorption anisotropic layer A3 were tilted with respect to the normal direction thereof.

### Example 3

### <Preparation of Optical Film A5>

A light absorption anisotropic layer A5 was formed and an optical film A5 was prepared using the same method as that of the preparation of the optical film A1, except that the composition P1 for forming a light absorption anisotropic layer was changed to the following composition P5 for forming a light absorption anisotropic layer, and the film thickness of the light absorption anisotropic layer was changed to 0.5 μm.

Composition of composition 5 for forming
light absorption anisotropic layer

| | |
|---|---|
| Dichroic substance D-1 shown above | 0.63 parts by mass |
| Dichroic substance D-2 shown above | 0.17 parts by mass |
| Dichroic substance D-3 shown above | 1.13 parts by mass |
| Polymer liquid crystal compound P-1 | 7.12 parts by mass |
| shown above | |
| Low-molecular-weight liquid crystal | 1.00 parts by mass |
| compound M-1 shown above | |
| IRGACURE OXE-02 (manufactured by | 0.16 parts by mass |
| BASF SE) | |
| Compound E-1 shown above | 0.12 parts by mass |
| Compound E-2 shown above | 0.12 parts by mass |
| Surfactant F-1 shown above | 0.35 parts by mass |
| Cyclopentanone | 85.00 parts by mass |
| Benzyl alcohol | 4.50 parts by mass |

### <Preparation of Optical Laminate A3>

The coating layer side of the optical film A3 and the optical rotation layer side of the transfer film were bonded to face each other using a commercially available pressure sensitive adhesive (SK2057, manufactured by Soken Chemical & Engineering Co., Ltd.). Next, the peelable support of the transfer film was peeled off. Further, the optical rotation layer surface and the coating layer of the optical film A5 were bonded to face each other using a commercially available pressure sensitive adhesive (SK2057, manufactured by Soken Chemical & Engineering Co., Ltd.). Further, the support surface of the optical film A5 and the optical rotation layer side of the transfer film were bonded to face each other using a commercially available pressure sensitive adhesive (SK2057, manufactured by Soken Chemical & Engineering Co., Ltd.). Next, the peelable support of the transfer film was peeled off. Next, the optical rotation layer side and the coating layer side of the newly prepared optical film A5 were bonded to face each other, and an optical laminate A3 was prepared.

### Example 4

### [Formation of λ/2 Wave Plate]

<Synthesis of Monomer mA-1>

4-aminocyclohexanol (50.0 g), triethylamine (48.3 g), and N,N-dimethylacetamide (800 g) were weighed in a 2 L three-neck flask including a stirring blade, a thermometer, a dropping funnel, and a reflux pipe, and were stirred under ice cooling.

Next, methacrylic acid chloride (47.5 g) was added dropwise to the above-described flask over 40 minutes using the dropping funnel, and after completion of the dropwise addition, the reaction solution was stirred at 40° C. for 2 hours.

The reaction solution was cooled to room temperature (23° C.), and was filtered under reduced pressure to remove the precipitated salt. The obtained organic layer was transferred to a 2 L three-neck flask including a stirring blade, a thermometer, a dropping funnel, and a reflux pipe, and was stirred under water cooling.

Next, N,N-dimethylaminopyridine (10.6 g) and triethylamine (65.9 g) were added to the flask, and 4-n-octyloxy cinnamic acid chloride (127.9 g) dissolved previously in tetrahydrofuran (125 g) was added dropwise to the flask using the dropping funnel over 30 minutes. After completion of the dropwise addition, the reaction solution was stirred at 50° C. for 6 hours. The reaction solution was cooled to room temperature, separation and washing were performed with water, the obtained organic layer was dried with anhydrous magnesium sulfate, and the obtained solution was concentrated to obtain a yellowish white solid.

The obtained yellowish white solid was heated and dissolved in methyl ethyl ketone (400 g) to be recrystallized. As a result, 76 g of a monomer mA-1 shown below was obtained as a white solid (yield: 40%).

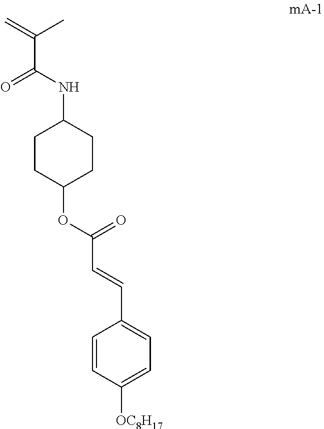

### <Other Monomers>

As the following monomer mB-1, CYCLOMER M-100 (manufactured by Daicel Corporation) was used.

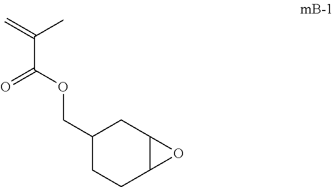

### <Synthesis of Polymer P-1>

A flask including a cooling pipe, a thermometer, and a stirrer was charged with 2-butanone (5 parts by mass) as a solvent, and while flowing nitrogen in the flask at 5 mL/min, the solvent was refluxed by heating in a water bath. A solution obtained by mixing the monomer mA-1 (1.2 parts by mass), the monomer mB-1 (8.8 parts by mass), 2,2′-azobis(isobutyronitrile) (1 part by mass) as a polymerization initiator, and 2-butanone (5 parts by mass) as a solvent was added dropwise thereto over 3 hours, and the obtained reaction solution was stirred while maintaining the reflux state for 3 hours. After completion of the reaction, the reaction solution was allowed to cool to room temperature, and 2-butanone (30 parts by mass) was added to the reaction solution for dilution to obtain a polymer solution having a polymer concentration of approximately 20% by mass. The obtained polymer solution was poured into a large excess of methanol to precipitate the polymer, the precipitate was separated by filtration, and the obtained solid content was washed with a large amount of methanol, and then subjected to blast drying at 50° C. for 12 hours, thereby obtaining a polymer P-1 having a photo-aligned group.

### <Preparation of Composition for Forming Photo-Alignment Film>

A composition for forming a photo-alignment film was prepared as follows.

Composition for Forming Photo-Alignment Film

| | | |
|---|---|---|
| Polymer P-1 described above | 100.00 | parts by mass |
| Thermal acid generator G-1 shown below | 3.00 | parts by mass |
| Diisopropylethylamine | 0.60 | parts by mass |
| Butyl acetate | 953.12 | parts by mass |
| Methyl ethyl ketone | 238.28 | parts by mass |

Thermal Acid Generator G-1

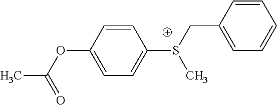

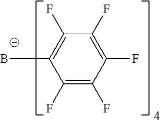

The prepared composition for forming a photo-alignment film was sealed in a glass bottle, and was stored at normal temperature in the sealed state for 7 days.

### <Formation of λ/2 Plate>

The composition for forming a photo-alignment film stored for 7 days was applied using a bar coater to one surface of a cellulose acylate film (TAC substrate; TG40, manufactured by FUJIFILM Corporation) having a thickness of 40 μm. Next, the film to which the composition for forming a photo-alignment film was applied was dried on a hot plate at 125° C. for 2 minutes to remove the solvent, and a precursor film having a thickness of 0.3 μm was formed. The obtained precursor film was irradiated with polarized ultraviolet light (8 mJ/cm², using an ultra-high-pressure mercury lamp) to form a photo-alignment film.

Next, the following coating liquid B for a retardation layer was applied using a bar coater to the photo-alignment film. The coating film formed on the photo-alignment film was heated to 120° C. with hot air and cooled to 60° C. Next, the coating film was irradiated with ultraviolet light at 100 mJ/cm² at a wavelength of 365 nm using a high-pressure mercury lamp under a nitrogen atmosphere. Next, the coating film was irradiated with ultraviolet light at 500 mJ/cm² while being heated to 120° C. Through the above-described procedure, the alignment of the liquid crystal compound was immobilized to prepare a λ/2 wave layer. Re(550) of the obtained laminate (cellulose acylate film/photo-alignment film λ/2 wave layer) was 270 nm, and the laminate was a λ/2 plate.

Coating liquid B for retardation layer

| | | |
|---|---|---|
| Polymerizable liquid crystal compound L-1 shown below | 39.00 | parts by mass |
| Polymerizable liquid crystal compound L-2 shown below | 39.00 | parts by mass |
| Polymerizable liquid crystal compound L-3 shown below | 17.00 | parts by mass |
| Polymerizable liquid crystal compound A-1 shown below | 5.00 | parts by mass |
| Polymerization initiator S-1 (oxime type) shown below | 0.50 | parts by mass |
| Surfactant F-3 shown above | 0.10 | parts by mass |
| Cyclopentanone | 235.00 | parts by mass |

Polymerizable Liquid Crystal Compound L-1 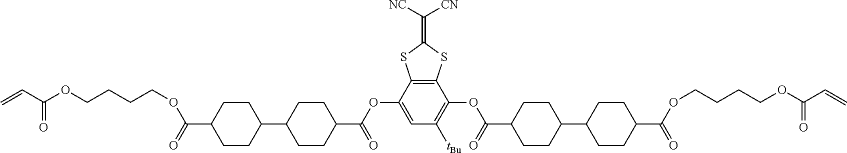 [SMILES: C=CC(=O)OCCCCOC(=O)C1CCC(C2CCC(C(=O)Oc3cc(C(C)(C)C)c(OC(=O)C4CCC(C5CCC(C(=O)OCCCCOC(=O)C=C)CC5)CC4)c4c3SC(=C(C#N)C#N)S4)CC2)CC1]
Polymerizable Liquid Crystal Compound L-2 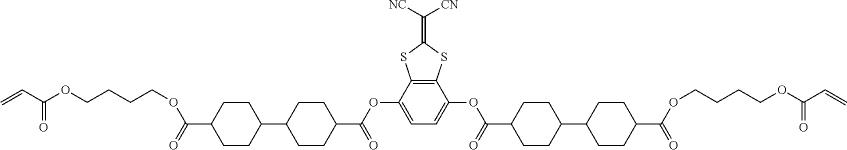 [SMILES: C=CC(=O)OCCCCOC(=O)C1CCC(C2CCC(C(=O)Oc3ccc(OC(=O)C4CCC(C5CCC(C(=O)OCCCCOC(=O)C=C)CC5)CC4)c4c3SC(=C(C#N)C#N)S4)CC2)CC1]
Polymerizable Liquid Crystal Compound L-3 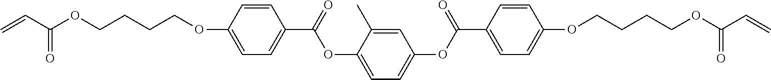 [SMILES: C=CC(=O)OCCCCOc1ccc(C(=O)Oc2ccc(OC(=O)c3ccc(OCCCCOC(=O)C=C)cc3)c(C)c2)cc1]
Polymerizable Liquid Crystal Compound A-1 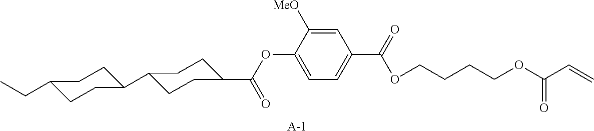
Polymerization Initiator S-1

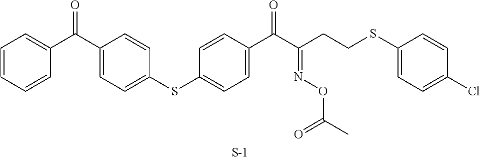

### <Preparation of Optical Laminate A4>

The coating layer side of the optical film A2 and the coating layer side of the λ/2 plate were bonded to face each other using a commercially available pressure sensitive adhesive (SK2057, manufactured by Soken Chemical & Engineering Co., Ltd.). Next, the peelable support of the λ/2 plate was peeled off. In this case, the light absorption anisotropic layer A2 and the λ/2 plate were bonded such that an angle between the orientation in the in-plane direction of the transmittance central axis of the light absorption anisotropic layer A2 and the slow axis of the λ/2 plate was 45°. Further, the peeling surface of the λ/2 plate and the coating layer of the newly prepared λ/2 plate were bonded to face each other using a commercially available pressure sensitive adhesive (SK2057, manufactured by Soken Chemical & Engineering Co., Ltd.). Next, the peelable support of the λ/2 plate was peeled off. In this case, the two λ/2 plates were bonded such that an angle between the slow axes of the two λ/2 plates was 45°. Further, the peeling surface and the coating layer of the newly prepared optical film A2 were bonded to face each other using a commercially available pressure sensitive adhesive (SK2057, manufactured by Soken Chemical & Engineering Co., Ltd.). In this case, the two light absorption anisotropic layers A2 were bonded such that an angle between orientations in the in-plane direction of the transmittance central axes thereof was 180°. That is, as in the relationship between the second light absorption anisotropic layer 16A and the third light absorption anisotropic layer 20A shown in FIG. 1, the two light absorption anisotropic layers A2 were bonded such that the transmittance central axes thereof were tilted with respect to the normal direction thereof.

Next, the two λ/2 plates were bonded using the same method on the support surface of the light absorption anisotropic layer A2. Next, the coating layer of the λ/2 plate and the coating layer side of the optical film A1 were bonded to face each other, and an optical laminate A4 was prepared.

### Example 5

### [Preparation of TN Liquid Crystal Cell]

A horizontal alignment polyimide alignment film was applied to two glass substrates with ITO electrodes, was dried at a high temperature to form an alignment film, and was rubbed to form a TN liquid crystal cell. Specifically, an alignment treatment was performed so as to impart a 90° twist in the vertical direction.

Thereafter, a thermosetting sealing material was sprayed to one of the two substrates, and a bead spacer (diameter of 5 μm) was sprayed to the other substrate, and the two substrates were bonded to each other, vacuum-packed, and heated to form an empty liquid crystal cell.

A liquid crystal with positive dielectric anisotropy, a refractivity anisotropy Δn of 0.0854 (589 nm, 20° C.), and Δε of +8.5 (MLC-9100, manufactured by Merck KGaA) was injected to the cell using a vacuum liquid crystal injector, and the cell was sealed to prepare a TN liquid crystal cell having Δnd of 450 nm.

Further, since the inner surfaces of the upper and lower substrates were rubbed, the liquid crystal layer was twisted and aligned at a twisted angle of 90° between the upper and lower substrates at the time of voltage application, and a TN liquid crystal cell in which liquid crystals were vertically aligned by applying the voltage was completed. Further, a liquid crystal cell having a twisted structure with an optional And was able to be formed by adjusting the spacer diameter.

### <Preparation of Optical Laminate A5>

An optical laminate A5 was prepared using the same method as that of the preparation of the optical laminate A1, except that the optical rotation layer was changed to the TN liquid crystal cell.

### Example 6

### <Preparation of Optical Laminate A6>

The coating layer side of the optical film A2 and the coating layer side of the λ/2 plate were bonded to face each other using a commercially available pressure sensitive adhesive (SK2057, manufactured by Soken Chemical & Engineering Co., Ltd.). Next, the peelable support of the λ/2 plate was peeled off. In this case, the light absorption anisotropic layer A2 and the λ/2 plate were bonded such that an angle between the orientation in the in-plane direction of the transmittance central axis of the light absorption anisotropic layer A2 and the slow axis of the λ/2 plate was 45°. Further, the peeling surface and the coating layer of the newly prepared optical film A2 were bonded to face each other using a commercially available pressure sensitive adhesive (SK2057, manufactured by Soken Chemical & Engineering Co., Ltd.). In this case, the two light absorption anisotropic layers A2 were bonded such that an angle between orientations in the in-plane direction of the transmittance central axes thereof was 180°. That is, as in the relationship between the second light absorption anisotropic layer 16A and the third light absorption anisotropic layer 20A shown in FIG. 1, the two light absorption anisotropic layers A2 were bonded such that the transmittance central axes thereof were tilted with respect to the normal direction thereof.

Next, the λ/2 plates were bonded using the same method on the support surface of the light absorption anisotropic layer A2. Next, the coating layer of the λ/2 plate and the coating layer side of the optical film A1 were bonded to face each other, and an optical laminate A6 was prepared.

### Example 7

### <Preparation of Optical Film A6>

A light absorption anisotropic layer A6 was formed and an optical film A6 was prepared using the same method as that of the preparation of the optical film A4, except that the composition P4 for forming a light absorption anisotropic layer was changed to the following composition P2 for forming a light absorption anisotropic layer, and the film thickness of the light absorption anisotropic layer was changed to 2.5 μm.

### <Preparation of Optical Laminate A7>

The coating layer side of the optical film A6 and the optical rotation layer side of the transfer film were bonded to face each other using a commercially available pressure sensitive adhesive (SK2057, manufactured by Soken Chemical & Engineering Co., Ltd.). Next, the peelable support of the transfer film was peeled off. Further, the optical rotation layer surface and the coating layer of the optical film A2 were bonded to face each other using a commercially available pressure sensitive adhesive (SK2057, manufactured by Soken Chemical & Engineering Co., Ltd.). In this case, the light absorption anisotropic layer A6 and the light absorption anisotropic layer A2 were bonded such that an angle between orientations in the in-plane direction of the transmittance central axes thereof was 180°. That is, as in the relationship between the second light absorption anisotropic layer 16A and the third light absorption anisotropic layer 20A shown in FIG. 1, the light absorption anisotropic layer A6 and the light absorption anisotropic layer A2 were bonded such that the transmittance central axis of the light absorption anisotropic layer A6 and the transmittance central axis of the light absorption anisotropic layer A2 were tilted with respect to the normal direction thereof. Further, the support surface of the optical film A2 and the optical rotation layer side of the transfer film were bonded to face each other using a commercially available pressure sensitive adhesive (SK2057, manufactured by Soken Chemical & Engineering Co., Ltd.). Next, the peelable support of the transfer film was peeled off. Next, the optical rotation layer side and the coating layer side of the optical film A1 were bonded to face each other, and an optical laminate A7 was prepared.

### Comparative Example 1

### <Preparation of Polarizing Plate>

A polarizing plate in which a thickness of a polarizer was 8 μm and one surface of the polarizer was exposed was prepared using the same method as that of a polarizing plate 02 with a one-surface protective film, described in WO2015/166991A.

### <Preparation of Optical Film A7>

A light absorption anisotropic layer A7 was formed and an optical film A7 was prepared using the same method as that of the preparation of the optical film A4, except that the composition P4 for forming a light absorption anisotropic layer was changed to the following composition P3 for forming a light absorption anisotropic layer, and the film thickness of the light absorption anisotropic layer was changed to 3.5 μm.

### <Preparation of Optical Laminate B1>

The polarizer side of the polarizing plate and the coating layer side of the optical film A7 were bonded to face each other using a commercially available pressure sensitive adhesive (SK2057, manufactured by Soken Chemical & Engineering Co., Ltd.). As a result, an optical laminate B1 was prepared. In this case, the light absorption anisotropic layer A7 and the polarizing plate were bonded such that an angle between the orientation in the in-plane direction of the transmittance central axis of the light absorption anisotropic layer A7 and the absorption axis of the polarizing plate was 90°.

### Comparative Example 2

The coating layer side of the optical film A1 and the optical rotation layer side of the transfer film were bonded to face each other using a commercially available pressure sensitive adhesive (SK2057, manufactured by Soken Chemical & Engineering Co., Ltd.). Next, the peelable support of the transfer film was peeled off. Further, the optical rotation layer surface and the coating layer of the newly prepared optical film A1 were bonded to face each other using a commercially available pressure sensitive adhesive (SK2057, manufactured by Soken Chemical & Engineering Co., Ltd.). As a result, an optical laminate B2 was prepared.

### Comparative Example 3

The coating layer side of the optical film A7 and the optical rotation layer side of the transfer film were bonded to face each other using a commercially available pressure sensitive adhesive (SK2057, manufactured by Soken Chemical & Engineering Co., Ltd.). Next, the peelable support of the transfer film was peeled off. Further, the optical rotation layer surface and the coating layer of the newly prepared optical film A7 were bonded to face each other using a commercially available pressure sensitive adhesive (SK2057, manufactured by Soken Chemical & Engineering Co., Ltd.). In this case, the two light absorption anisotropic layers A7 were bonded such that an angle between orientations in the in-plane direction of the transmittance central axes thereof was 0°. As a result, an optical laminate B3 was prepared.

### Comparative Example 4

The coating layer side of the optical film A4 and the polarizer side of the polarizing plate were bonded to face each other using a commercially available pressure sensitive adhesive (SK2057, manufactured by Soken Chemical & Engineering Co., Ltd.). In this case, the light absorption anisotropic layer A4 and the polarizing plate were bonded such that an angle between the orientation in the in-plane direction of the transmittance central axis of the light absorption anisotropic layer A4 and the absorption axis of the polarizing plate was 90°. Further, the support side of the polarizing plate and the coating layer of the optical film A3 were bonded to face each other using a commercially available pressure sensitive adhesive (SK2057, manufactured by Soken Chemical & Engineering Co., Ltd.). As a result, an optical laminate B4 was prepared. In this case, the light absorption anisotropic layer A3 and the polarizing plate were bonded such that an angle between the orientation in the in-plane direction of the transmittance central axis of the light absorption anisotropic layer A3 and the absorption axis of the polarizing plate was 90°.

### Comparative Example 5

The optical laminate B2 and the optical rotation layer side of the transfer film were bonded to face each other using a commercially available pressure sensitive adhesive (SK2057, manufactured by Soken Chemical & Engineering Co., Ltd.). Next, the peelable support of the transfer film was peeled off. Further, the optical rotation layer surface and the coating layer of the newly prepared optical film A1 were bonded to face each other using a commercially available pressure sensitive adhesive (SK2057, manufactured by Soken Chemical & Engineering Co., Ltd.). As a result, an optical laminate B5 was prepared.

### Comparative Example 6

The optical laminate B3 and the optical rotation layer side of the transfer film were bonded to face each other using a commercially available pressure sensitive adhesive (SK2057, manufactured by Soken Chemical & Engineering Co., Ltd.). Next, the peelable support of the transfer film was peeled off. Further, the optical rotation layer surface and the coating layer of the newly prepared optical film A7 were bonded to face each other using a commercially available pressure sensitive adhesive (SK2057, manufactured by Soken Chemical & Engineering Co., Ltd.). In this case, the three light absorption anisotropic layers A7 were bonded such that orientations in the in-plane direction of the transmittance central axes thereof were the same. As a result, an optical laminate B6 was prepared.

### Comparative Example 7

### <Preparation of Optical Laminate B7>

The polarizer side of the polarizing plate and the coating layer side of the optical film A2 were bonded to face each other using a commercially available pressure sensitive adhesive (SK2057, manufactured by Soken Chemical & Engineering Co., Ltd.). In this case, the light absorption anisotropic layer A2 and the polarizing plate were bonded such that an angle between the orientation in the in-plane direction of the transmittance central axis of the light absorption anisotropic layer A2 and the absorption axis of the polarizing plate was 90°. Further, the support surface of the optical film A2 and the coating layer of the optical film A1 were bonded to face each other using a commercially available pressure sensitive adhesive (SK2057, manufactured by Soken Chemical & Engineering Co., Ltd.). Further, the support surface of the optical film A1 and the coating layer of the newly prepared optical film A2 were bonded to face each other using a commercially available pressure sensitive adhesive (SK2057, manufactured by Soken Chemical & Engineering Co., Ltd.). In this case, the two light absorption anisotropic layers A2 were bonded such that an angle between orientations in the in-plane direction of the transmittance central axes thereof was 180°. As a result, an optical laminate B6 was prepared.

### [Evaluation of Optical Laminate]

### (1) Symmetry Evaluation

An optical laminate obtained in each of Examples and Comparative Examples was placed on a plane light source (LED VIEWER PRO HR, manufactured by FUJIFILM Corporation), and in a case where the optical laminate was seen while changing the angle from the front direction to the left-right direction or the up-down direction, the symmetry of darkness was evaluated based on the following standards. The results are shown in Table 1 below.

### <Standards>

A: In a case where the optical laminate was seen while changing the angle to left-right or up-down direction, a change in brightness between the left direction and the right direction or between the upward direction and the downward direction was observed.
B: In a case where the optical laminate was seen while changing the angle to left-right or up-down direction, a change in brightness between the left direction and the right direction or between the upward direction and the downward direction was not observed.

### (2) Front Evaluation

Regarding the optical laminate obtained in each of Examples and Comparative Examples, the Mueller matrix at a wavelength of 550 nm was measured using AxoScan OPMF-2 (manufactured by Axometrics, Inc.) to evaluate the position of the transmittance central axis of the optical laminate. Specifically, in the measurement, an azimuthal angle at which the transmittance central axis was tilted was first searched for, the Mueller matrix at a wavelength of 550 nm was measured while changing the polar angle which was the angle with respect to the normal direction of the surface of the light absorption anisotropic layer from −70° to 70° at intervals of 1° in the surface (the plane that had the transmittance central axis and was orthogonal to the layer surface) having the normal direction of the light absorption anisotropic layer along the azimuthal angle, a direction of the transmittance central axis of the optical laminate was derived, and the evaluation was performed based on the following standards. The results are shown in tables below. As the angle between the transmittance central axis and the normal direction decreases, a luminance on the front surface increases in a case where the optical laminate is disposed on a light source.

### <Standards>

AA: The angle between the transmittance central axis and the normal direction of the optical laminate was 0° or more and 1° or less.
A: The angle between the transmittance central axis and the normal direction of the optical laminate was more than 1° and 3° or less.
B: The angle between the transmittance central axis and the normal direction of the optical laminate was more than 3° and 6° or less.
C: The angle between the transmittance central axis and the normal direction of the optical laminate was more than 6°.

In Tables 1 and 2, each of the members forming the optical laminate is shown in the field “Configuration”.

In “Optical Film (X°,Y°)” of Tables 1 and 2, X° represents the angle of the polar angle from the normal direction of the transmittance central axis, and Y° represents the azimuthal angle of the transmittance central axis. The expression “0°,−” represents that the transmittance central axis is parallel to the normal direction. In addition, for example, “Optical Film A2) (10°,0°)” represents that the angle (polar angle) of the transmittance central axis of the optical film A2 with respect to the normal direction was 10° and the azimuthal angle of the transmittance central axis was 0°.

The field “Aspect” of Table 1 shows which one of the first to third aspects the optical laminate according to each of Examples corresponds.

Example 3 corresponds to the third aspect as shown in the tables below, the transmittance of the light absorption anisotoropic layer in the direction along the transmittance central axis of the light absorption anisotoropic layer in the optical film A5 was 87%, and the transmittance of the light absorption anisotoropic layer in the direction along the transmittance central axis of the light absorption anisotoropic layer in the optical film A3 was 73%. Accordingly, the average value AX was 87%, and the average value AY was 80%.

TABLE 1

| | Example 1 | Example 2 | Example 3 | Example 4 | Example 5 | Example 6 | Example 7 |
|---|---|---|---|---|---|---|---|
| Kind | Optical | Optical | Optical | Optical | Optical | Optical | Optical |
| | Laminate A1 | Laminate A2 | Laminate A3 | Laminate A4 | Laminate A5 | Laminate A6 | Laminate A7 |
| Configuration | Optical | Optical | Optical | Optical | Optical | Optical | Optical |
| | Film A1 | Film A3 | Film A5 | Film A1 | Film A1 | Film A1 | Film A1 |
| | (0°, —) | (5°, 0°) | (0°, —) | (0°, —) | (0°, —) | (0°, —) | (0°, —) |
| | Optical | Optical | Optical | λ/2 Wave | TN Liquid | λ/2 Wave | Optical |
| | Rotation | Rotation | Rotation | Plate | Crystal Cell | Plate | Rotation |
| | Layer | Layer | Layer | Slow Axis: | | Slow Axis: | Layer |
| | | | | 0° | | 45° | |
| | Optical | Optical | Optical | λ/2 Wave | Optical | Optical | Optical |
| | Film A2 | Film A4 | Film A5 | Plate | Film A2 | Film A2 | Film A2 |
| | (10°, 0°) | (20°, 180°) | (0°, —) | Slow Axis: | (10°, 0°) | (10°, 0°) | (10°, 0°) |
| | | | | 45^{°} | | | |
| | Optical | | Optical | Optical | TN Liquid | λ/2 Wave | Optical |
| | Rotation | | Rotation | Film A2 | Crystal Cell | Plate | Rotation |
| | Layer | | Layer | (10°, 0°) | | Slow Axis: | Layer |
| | | | | | | 45° | |
| | Optical | | Optical | λ/2 Wave | Optical | Optical | Optical |
| | Film A2 | | Film A3 | Plate | Film A2 | Film A2 | Film A2 |
| | (10°, 180°) | | (5°, 0°) | Slow Axis: | (10°, 180°) | (10°, 180°) | (20°, 180°) |
| | | | | 0° | | | |
| | | | | λ/2 Wave | | | |
| | | | | Plate | | | |
| | | | | Slow Axis: | | | |
| | | | | 45° | | | |
| | | | | Optical | | | |
| | | | | Film A2 | | | |
| | | | | (10°, 180°) | | | |
| Aspect | First Aspect | Second Aspect | Third Aspect | First Aspect | First Aspect | First Aspect | First Aspect |
| Number of Light | 3 | 2 | 3 | 3 | 3 | 3 | 3 |
| Absorption | | | | | | | |
| Anisotropic | | | | | | | |
| Layers | | | | | | | |
| Number of | 2 | 1 | 2 | 2 | 2 | 2 | 2 |
| Retardation Layers | | | | | | | |
| or Liquid Crystal | | | | | | | |
| Cells | | | | | | | |
| Kind of Retardation | Optical | Optical | Optical | λ/2 Wave | TN Liquid | λ/2 Wave | Optical |
| Layer or Liquid | Rotation | Rotation | Rotation | Plate | Crystal Cell | Plate | Rotation |
| Crystal Cell | Layer | Layer | Layer | (Two-Layer | | | Layer |
| | | | | Configuration) | | | |
| Symmetry Evaluation | A | A | A | A | A | A | A |
| Front Evaluation | AA | B | A | AA | AA | AA | A |

TABLE 2

| | Comparative | Comparative | Comparative | Comparative | Comparative | Comparative | Comparative |
|---|---|---|---|---|---|---|---|
| | Example 1 | Example 2 | Example 3 | Example 4 | Example 5 | Example 6 | Example 7 |
| Kind | Optical | Optical | Optical | Optical | Optical | Optical | Optical |
| | Laminate B1 | Laminate B2 | Laminate B3 | Laminate B4 | Laminate B5 | Laminate B6 | Laminate B7 |
| Configuration | Polarizing Plate | Optical | Optical | Optical | Optical | Optical | Optical |
| | Absorption | Film A1 | Film A7 | Film A3 | Film A1 | Film A7 | Film A2 |
| | Axis: 90° | (0°, —) | (20°, 0°) | (5°, 0°) | (0°, —) | (20°, 0°) | (10°, 0°) |
| | Optical | Optical Rotation | Optical Rotation | Polarizing Plate | Optical Rotation | Optical Rotation | Optical |
| | Film A7 | Layer | Layer | Absorption | Layer | Layer | Film A1 |
| | (20°, 180°) | | | Axis: 90° | | | (0°, —) |
| | | Optical | Optical | Optical | Optical | Optical | Optical |
| | | Film A1 | Film A7 | Film A4 | Film A1 | Film A7 | Film A2 |
| | | (0°, —) | (20°, 0°) | (20°, 180°) | (0°, —) | (20°, 0°) | (10°, 180°) |
| | | | | | Optical Rotation | Optical Rotation | Polarizing Plate |
| | | | | | Layer | Layer | Absorption |
| | | | | | | | Axis: 90° |
| | | | | | Optical | Optical | |
| | | | | | Film A1 | Film A7 | |
| | | | | | (0°, —) | (20°, 0°) | |
| Number of Light | 1 | 2 | 2 | 2 | 3 | 3 | 3 |
| Absorption | | | | | | | |
| Anisotropic Layers | | | | | | | |
| Number of | None | 1 | 1 | None | 2 | 2 | None |
| Retardation Layers | | | | | | | |
| or Liquid Crystal | | | | | | | |
| Cells | | | | | | | |
| Kind of Retardation | None | Optical Rotation | Optical Rotation | None | Optical Rotation | Optical Rotation | None |
| Layer or Liquid | | Layer | Layer | | Layer | Layer | |
| Crystal Cell | | | | | | | |
| Symmetry Evaluation | A | B | A | A | B | A | B |
| Front Evaluation | C | AA | C | C | AA | C | AA |

From the above tables, it was found that the optical laminate according to the embodiment of the present invention had a desired effect.

From the above tables, it was found that the effect was higher than that of the first aspect.

### EXPLANATION OF REFERENCES

10A, 10B, 10C: optical laminate
12A, 12B, 12C: first light absorption anisotropic layer
14A, 14C: first retardation layer
14B: retardation layer
16A, 16B, 16C: second light absorption anisotropic layer
18A, 18C: first retardation layer
20A, 20C: third light absorption anisotropic layer

What is claimed is:

1. An optical laminate comprising, in the following order:
a first light absorption anisotropic layer;
a first retardation layer or a first liquid crystal cell;
a second light absorption anisotropic layer;
a second retardation layer or a second liquid crystal cell; and
a third light absorption anisotropic layer,
wherein an angle A1 between a transmittance central axis of the first light absorption anisotropic layer and a normal direction of the first light absorption anisotropic layer is 0° to 45°,
an angle A2 between a transmittance central axis of the second light absorption anisotropic layer and a normal direction of the second light absorption anisotropic layer is more than 0° and 45° or less,
an angle A3 between a transmittance central axis of the third light absorption anisotropic layer and a normal direction of the third light absorption anisotropic layer is more than 0° and 45° or less,
the transmittance central axis of the first light absorption anisotropic layer and the transmittance central axis of the second light absorption anisotropic layer are not parallel to each other,
an angle between an orientation in an in-plane direction of the transmittance central axis of the second light absorption anisotropic layer and an orientation in an in-plane direction of the transmittance central axis of the third light absorption anisotropic layer is 180°±20°,
the first retardation layer has a function of changing a direction of linearly polarized light incident from a normal direction of the first retardation layer to a direction having an angle of 90°±10° with respect to the direction and emitting the incident light,
the second retardation layer has a function of changing a direction of linearly polarized light incident from a normal direction of the second retardation layer to a direction having an angle of 90°±10° with respect to the direction and emitting the incident light,
the first liquid crystal cell and the second liquid crystal cell are each independently a liquid crystal cell in a TN mode, a liquid crystal cell in a VA mode, a liquid crystal cell in an OCB mode, or a liquid crystal cell in an ECB mode,
the liquid crystal cell in the TN mode is a liquid crystal cell that rotates by 80° to 100° linearly polarized light incident into the liquid crystal cell from a normal direction of the liquid crystal cell in a case where a liquid crystal compound in the liquid crystal cell is twisted and aligned, and
all of the liquid crystal cell in the VA mode, the liquid crystal cell in the OCB mode, and the liquid crystal cell in the ECB mode are liquid crystal cells where an in-plane retardation at a wavelength of 550 nm is switchable between 0 to 20 nm and 250 to 300 nm.

2. The optical laminate according to claim 1,
wherein an absolute value of a difference between the angle A2 and the angle A3 is 8° or less.

3. The optical laminate according to claim 1,
wherein the first retardation layer and the second retardation layer are each independently selected from the group consisting of a retardation layer obtained by immobilizing a liquid crystal compound that is twisted and aligned along a helical axis extending along a thickness direction, a λ/2 plate, and a laminate where two λ/2 plates are laminated such that an angle between in-plane slow axes of the two λ/2 plates is in a range of 45°±10°.

4. An optical laminate comprising, in the following order:
a first light absorption anisotropic layer;
a retardation layer or a liquid crystal cell; and
a second light absorption anisotropic layer,
wherein an angle A1 between a transmittance central axis of the first light absorption anisotropic layer and a normal direction of the first light absorption anisotropic layer is more than 0° and 45° or less,
an angle A2 between a transmittance central axis of the second light absorption anisotropic layer and a normal direction of the second light absorption anisotropic layer is more than 0° and 45° or less,
the angle A1 and the angle A2 are different,
an angle between an orientation in an in-plane direction of the transmittance central axis of the first light absorption anisotropic layer and an orientation in an in-plane direction of the transmittance central axis of the second light absorption anisotropic layer is 180°±20°,
the retardation layer has a function of changing a direction of linearly polarized light incident from a normal direction of the retardation layer to a direction having an angle of 90°±10° with respect to the direction and emitting the incident light,
the liquid crystal cell is a liquid crystal cell in a TN mode, a liquid crystal cell in a VA mode, a liquid crystal cell in an OCB mode, or a liquid crystal cell in an ECB mode,
the liquid crystal cell in the TN mode is a liquid crystal cell that rotates by 80° to 100° linearly polarized light incident into the liquid crystal cell in a case where a liquid crystal compound in the liquid crystal cell is twisted and aligned, and
all of the liquid crystal cell in the VA mode, the liquid crystal cell in the OCB mode, and the liquid crystal cell in the ECB mode are liquid crystal cells where an in-plane retardation at a wavelength of 550 nm is switchable between 0 to 20 nm and 250 to 300 nm.

5. The optical laminate according to claim 4,
wherein the retardation layer is selected from the group consisting of a retardation layer obtained by immobilizing a liquid crystal compound that is twisted and aligned along a helical axis extending along a thickness direction, a λ/2 plate, and a laminate where two λ/2 plates are laminated such that an angle between in-plane slow axes of the two λ/2 plates is in a range of 45°±10°.

6. An optical laminate comprising, in the following order:
a first light absorption anisotropic layer;
a first retardation layer or a first liquid crystal cell;
a second light absorption anisotropic layer;
a second retardation layer or a second liquid crystal cell; and
a third light absorption anisotropic layer,
wherein an angle A1 between a transmittance central axis of the first light absorption anisotropic layer and a normal direction of the first light absorption anisotropic layer is 0° to 10°,
an angle A2 between a transmittance central axis of the second light absorption anisotropic layer and a normal direction of the second light absorption anisotropic layer is 0° to 10°,
an angle A3 between a transmittance central axis of the third light absorption anisotropic layer and a normal direction of the third light absorption anisotropic layer is more than 0° and 45° or less,
an average value AX of a transmittance of the first light absorption anisotropic layer in a direction along the transmittance central axis of the first light absorption anisotropic layer and a transmittance of the second light absorption anisotropic layer in a direction along the transmittance central axis of the second light absorption anisotropic layer is more than an average value AY of the transmittance of the second light absorption anisotropic layer in the direction along the transmittance central axis of the second light absorption anisotropic layer and a transmittance of the third light absorption anisotropic layer in a direction along the transmittance central axis of the third light absorption anisotropic layer,
the angle A3 is more than any of the angle A1 or the angle A2,
the first retardation layer has a function of changing a direction of linearly polarized light incident from a normal direction of the first retardation layer to a direction having an angle of 90°±10° with respect to the direction and emitting the incident light,
the second retardation layer has a function of changing a direction of linearly polarized light incident from a normal direction of the second retardation layer to a direction having an angle of 90°±10° with respect to the direction and emitting the incident light,
the first liquid crystal cell and the second liquid crystal cell are each independently a liquid crystal cell in a TN mode, a liquid crystal cell in a VA mode, a liquid crystal cell in an OCB mode, or a liquid crystal cell in an ECB mode,
the liquid crystal cell in the TN mode is a liquid crystal cell that rotates by 80° to 100° linearly polarized light incident into the liquid crystal cell in a case where a liquid crystal compound in the liquid crystal cell is twisted and aligned, and
all of the liquid crystal cell in the VA mode, the liquid crystal cell in the OCB mode, and the liquid crystal cell in the ECB mode are liquid crystal cells where an in-plane retardation at a wavelength of 550 nm is switchable between 0 to 20 nm and 250 to 300 nm.

7. The optical laminate according to claim 6,
wherein the first retardation layer and the second retardation layer are each independently selected from the group consisting of a retardation layer obtained by immobilizing a liquid crystal compound that is twisted and aligned along a helical axis extending along a thickness direction, a λ/2 plate, and a laminate where two λ/2 plates are laminated such that an angle between in-plane slow axes of the two λ/2 plates is in a range of 45°±10°.

8. An image display apparatus comprising:
an image display element; and
the optical laminate according to claim 1.

9. The optical laminate according to claim 2,
wherein the first retardation layer and the second retardation layer are each independently selected from the group consisting of a retardation layer obtained by immobilizing a liquid crystal compound that is twisted and aligned along a helical axis extending along a thickness direction, a λ/2 plate, and a laminate where two λ/2 plates are laminated such that an angle between in-plane slow axes of the two λ/2 plates is in a range of 45°±10°.

10. An image display apparatus comprising:
an image display element; and
the optical laminate according to claim 2.

11. An image display apparatus comprising:
an image display element; and
the optical laminate according to claim 3.

12. An image display apparatus comprising:
an image display element; and
the optical laminate according to claim 4.

13. An image display apparatus comprising:
an image display element; and
the optical laminate according to claim 5.

14. An image display apparatus comprising:
an image display element; and
the optical laminate according to claim 6.

15. An image display apparatus comprising:
an image display element; and
the optical laminate according to claim 7.
